(19) United States
(12) Patent Application Publication
(10) Pub. No.: US 2019/0213522 A1
(43) Pub. Date: Jul. 11, 2019

(54) SYSTEM AND METHOD FOR DETERMINING USER METRICS

(71) Applicant: ITY Labs Corp., San Jose, CA (US)

(72) Inventors: Jose Cong, San Jose, CA (US); Seth Rogers, San Jose, CA (US); Jens Faenger, San Jose, CA (US); Thorsten Kuehnemund, San Jose, CA (US); Brad Eckert, San Jose, CA (US); Andrew Selvia, San Jose, CA (US); Marin Licina, San Jose, CA (US); Michael Stark, San Jose, CA (US)

(21) Appl. No.: 16/312,590

(22) PCT Filed: Jun. 28, 2017
(86) PCT No.: PCT/US2017/039773

§ 371 Date: Dec. 21, 2018

Related U.S. Application Data
(60) Provisional application No. 62/356,184, filed on Jun. 29, 2016.

(51) Int. Cl. G06Q 10/06; G06F 16/248; G06F 16/2455

(52) U.S. Cl. CPC G06Q 10/06398; G06F 16/2455; G06F 16/248

(57) ABSTRACT

Embodiments of a method and/or system for improving user metric determination associated with a workplace can include: presenting a query to a first user based on a role identifier identifying a workplace role for the first user, collecting a response to the query from the first user, determining a metric for the first user based on the response to the query, and presenting the metric to a second user based on a second role identifier identifying a second workplace role for the second user.

### CROSS-REFERENCE TO RELATED APPLICATIONS

This application claims the benefit of U.S. Provisional Application Ser. No. 62/356,184, filed on 29 Jun. 2016, which is incorporated in its entirety by this reference.

### TECHNICAL FIELD

This invention relates generally to the data management field, and more specifically to a new and useful system and method for improving data collection, analysis, and/or action recommendation associated with workplaces.

### BRIEF DESCRIPTION OF THE FIGURES

FIG. 1 is a flowchart diagram of an embodiment of a method.

FIG. 2 is a flowchart diagram of an embodiment of a method.

FIG. 3 is a schematic representation of a variation of query determination.

FIG. 4 is a schematic representation of an embodiment of a method.

FIG. 5 is a schematic representation of an embodiment of a method.

FIG. 6 is a specific example of query presentation.

FIG. 7 is a specific example of a validation construct.

FIG. 8 is a schematic representation of an embodiment of a method.

FIG. 9 is a schematic representation of an embodiment of a method.

FIG. 10 is a specific example of a user interface.

FIG. 11 is a specific example of a user interface, with a first and second user selected.

FIG. 12 is a specific example of snippets for a plurality of users.

FIG. 13 is a specific example of snippets for a plurality of users.

FIG. 14 is a specific example of a user interface.

FIG. 15 is a specific example of a user interface .

FIGS. 16-19 are specific examples of receiving validation constructs.

FIG. 20 is a specific example of a query.

FIG. 21 is a specific example of user metrics.

FIG. 22 is a specific example of user metric presentation.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

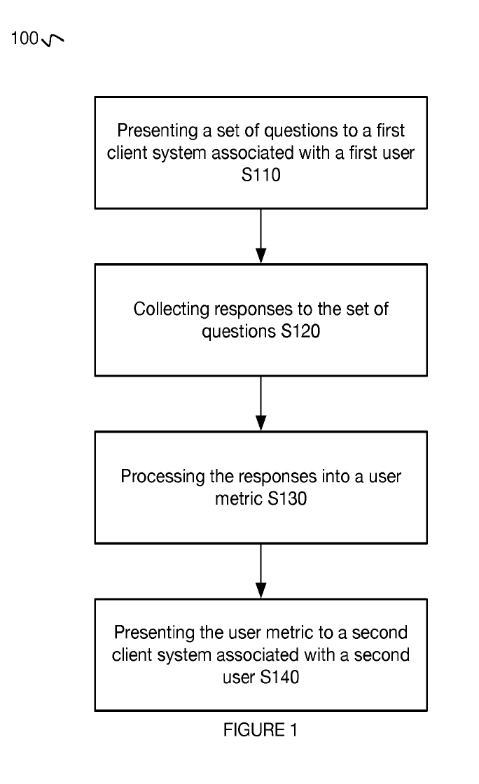

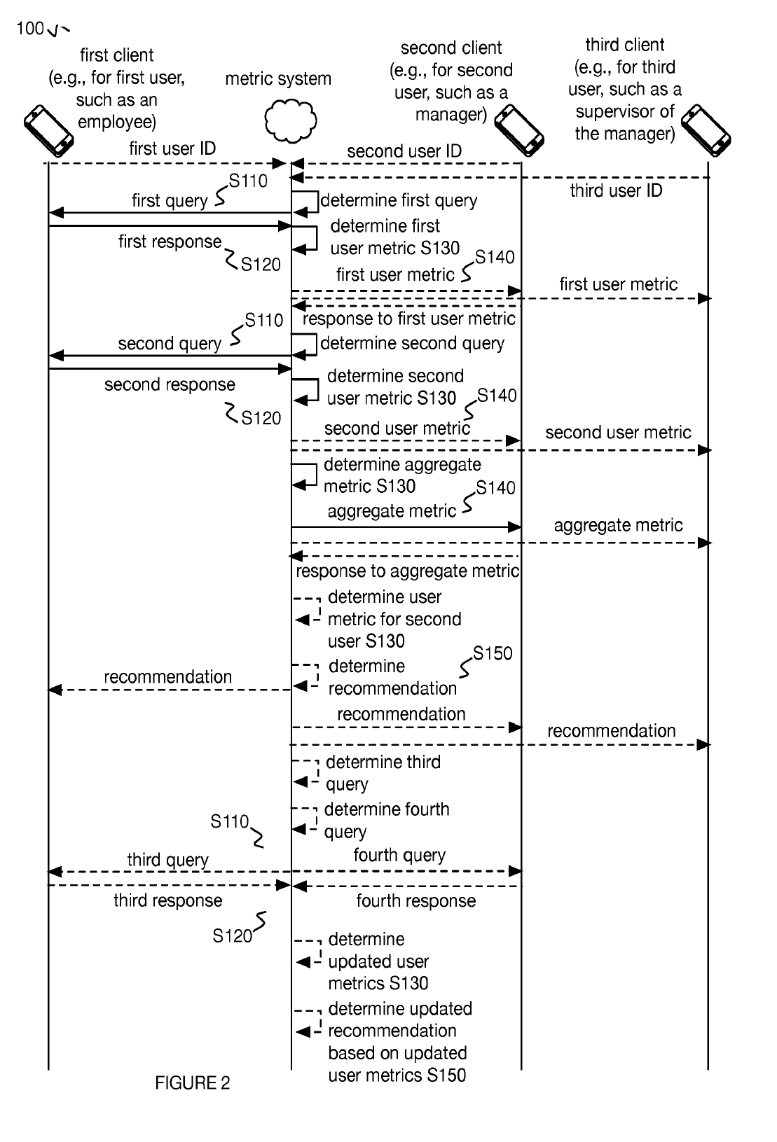

As shown in FIGS. 1-2 and 4-5, embodiments of a method 100 for improving user metric determination associated with a workplace can include: presenting a query to a first user based on a role identifier identifying a workplace role for the first user S110; collecting a response to the query from the first user S120; determining a metric (e.g., user metric) for the first user based on the response to the query S130; and presenting the metric to a second user based on a second role identifier identifying a second workplace role for the second user S140. Additionally or alternatively, embodiments of the method 100 can include: determining a workplace action (e.g., recommendation) based on the user metric S150, and/or any other suitable process.

The method 100 and/or system 200 can function to collect user data, organize the data (e.g., quantify the data; extract factor values correlated with user metrics; etc.), analyze the data (e.g., interpret the data; determine user metrics; etc.), and/or present the data to users (e.g., employees, managers, leadership such as the corporate suite, people operations such as human resources, etc.). The method 100 can additionally or alternatively function to predict user changes associated with the workplace, such as changes in performance, alignment, engagement, and/or any other suitable change. The method 100 can additionally or alternatively function to automatically recommend workplace actions (e.g., user actions to improve their skills, to correct undesired trends in user metrics; operations actions to mitigate negative effects of employee actions on other employees, to mitigate the occurrence of undesirable employee actions; managerial or leadership actions such as employee project or task assignment, employee team assignment; etc.) and/or generate any other suitable set of recommendations. However, the method 100 and/or system 200 can perform any suitable functionality.

In variants, the method 100 and/or system 200 can leverage social validation to improve user engagement with the system 200. For example, the system 200 can enable other users to give a user badges (e.g., “kudos”), publically praise other users, post your own achievements that can be validated by others, comments, upvotes, likes, or other forms of social validation, where all or part of the social validation can be visible to the user (e.g., on a homepage or personal content stream) and/or other users (e.g., on their homepage, personal content stream, project content stream, team content stream, etc.). These validation constructs can be used to socially validate the recipient user, validate the user's skill, and/or be used in any other suitable manner.

Additionally or alternatively, in variants, the method 100 and/or system 200 can provide ongoing information (e.g., insights, determined from the collected information; metrics; suggestions; etc.) to the user. In a first example, users (e.g., employee clients) can be provided with summaries, performance metrics, management feedback, improvement recommendations or plans (e.g., how to deal with stress, how to improve at a task or skill, etc.), tools and/or other resources (e.g., through which the employee can connect with their managers and/or peers). In a second example, users can be periodically provided with “highlights” about their performance or their peers' performance. In a first specific example, users can be provided with a summary of their work priorities on Monday, concerns on Wednesday, and accomplishments on Friday which can include feedback, which can be real-time feedback, from their managers in regards to agreement/disagreement so that users can have indications as to whether their managers have read the highlights and closed the communication loop. In a second specific example, users can be provided with a monthly summary of a set of their user factors (e.g., concerns, accomplishments, priorities, etc.). In a third specific example, users can be provided with updates for a project associated with their respective account (e.g., that the project is ahead of schedule, that the project is delayed, the part of the project that is delayed, etc.). In a fourth specific example, users can be provided with a list of their achievements and validation received for each by others, showing the amount of “agreement” in regards to multiple metrics. However, any other suitable information can be provided. In a second example, managers (e.g., manager clients) can be provided with user metrics about their employees, projects, and teams (e.g., via a dashboard), insights, achievements or highlights about employee potential and capabilities, recommendations (e.g., how to manage an employee, what projects or teams to assign an employee to, etc.), and/or any other suitable information. In a third example, leadership (e.g., leadership clients) can be provided with predictions (e.g., employee action predictions, etc.), alignment metrics across the workplace, recommendations (e.g., on how to increase awareness, communication, performance, trust, empowerment, etc.), highly rated achievements of employees or teams of employees, and/or any other suitable information. In a fourth example, people operations (e.g., operations clients) can be provided with objective employee data at a high frequency (e.g., instead of once a quarter or once a year), employee alerts, and/or any other suitable information. However, the method 100 and/or system 200 can leverage any suitable data to determine any suitable information for any suitable user type (e.g., workplace role).

Portions of the method 100 and/or system 200 can be applied (e.g., tailored, executed, etc.) for one or more users, roles, workplaces, and/or any other suitable set of users. One or more instances and/or portions of the method 100 and/or processes described herein can be performed asynchronously (e.g., sequentially), concurrently (e.g., in parallel for different users; concurrently on different threads for parallel computing to improve system processing ability for determining user metrics; etc.), in temporal relation to a condition, and/or in any other suitable order at any suitable time and frequency by and/or using one or more instances of the system 200, elements, and/or entities described herein. However, the method 100 and/or system 200 can be configured in any suitable manner.

### 2. Benefits

The method 100 and/or system 200 can confer several benefits over conventional methodologies. First, conventional approaches can apply separate tools for collecting different user data types, leading to challenges in accommodating the fragmented data storage and retrieval for subsequent analysis. Second, conventional approaches can fail to account for the interrelatedness between user metrics (e.g., engagement, performance, alignment, etc.) in calculating accurate user metrics (e.g., using computer-implemented rules) that describe users in a workplace. Third, conventional approaches can use a problematic distribution of functionality across a network that fails to account for the need to provide real-time, frequent (e.g., week over week, etc.) analyses of different types of user metrics, which can be used to accurately evaluate trends over time (e.g., a decreasing level of engagement; an increasing risk of employee attrition; etc.). Examples of the method 100 and/or system 200 can confer technologically-rooted solutions to at least the challenges described above.

First, the technology can confer improvements in computer-related technology (e.g., computational prediction of user metrics; data storage and retrieval; etc.). For example, the technology can apply computer-implemented rules (e.g., feature engineering rules for processing query responses into factor values correlated with user metrics in order to improve accuracy of determining the user metrics; threshold rules defining threshold conditions determinative of the types of user metrics generated, presented, and/or otherwise processed; computer-implemented rules tailored to different user identifiers, such as for different workplace roles; etc.) in conferring improvements to the computer-related technical field of computationally determining user metrics associated with a workplace.

Second, the increasing prevalence of digital data collection in the workplace can translate into a plethora of user data associated with a workplace, giving rise to challenges of processing the vast array of data, such as for generating user metric insights. However, the technology can address such challenges by providing a full-stack technology improving upon collection, storage, and processing of different types of user data. For example, the technology can aggregate such data into a cohesive database system (e.g., as part of a metric system for determining user metrics) describing users, associated workplace roles, relevant factor values indicative of user metrics, and appropriate user metrics (e.g., specific to workplace role), thereby enabling improvement of data storage and retrieval (e.g., through associating role-specific analysis modules with relevant role identifiers to improve subsequent retrieval of and/or analysis with the modules; etc.).

Third, the technology can amount to an inventive distribution of functionality across a network including a set of client systems, a metric system and/or other suitable components. The client systems can be utilized to provide personal data environments for different users (e.g., based on different workplace roles; for providing a transparent means through which user can monitor their progress at work such as evaluated by their peers and managers; etc.), which can lead to collection of different types of user data (e.g., indicative of different types of user metrics relevant to different types of workplace roles; etc.) across different users and/or workplace roles in a workplace. As such, the client system can present content personalized to a user and/or role (e.g., queries tailored to reduce required effort for a user to respond; tailored time conditions for responding to queries and/or performing another user action; etc.). The metric system (e.g., wirelessly communicable with the client systems) can aggregate, connect, analyze, and/or otherwise process the variety of user data (e.g., across different users, roles, projects, teams, workplaces, etc.), and thereby act as a central computational system that improves upon the processing of such workplace-related data.

Fourth, the technology can transform entities (e.g., users, user devices, user data, etc.) into different states or things. In a first example, the technology can transform user devices, such as through controlling and/or activating client systems (e.g., executing on the user device) to present user metrics, user actions, and/or other suitable data. In a second example, the technology can transform users along different user metric axes, such as through applying computer-implemented rules to selectively analyze specific user metrics and/or recommend specific user actions for a particular user who can act upon such data to improve user metric values.

Fifth, the technology can provide technical solutions necessarily rooted in computer technology (e.g., utilizing computational analysis modules for factor values and determining user metrics; dynamically updating analysis modules, such as through reinforcement, to optimize user metric improvement; data storage and retrieval tailored to processing user data for different types of user metrics; generating personalized content to users based on workplace roles; modifying perceptible digital elements associated with user data for optimized presentation of information at a lightweight and focused user interface; etc.) to overcome issues specifically arising with computer technology (e.g., fragmented workplace-related data processing across disjointed collection approaches, storage approaches, analysis approaches, presentation approaches; etc.).

Sixth, the technology can leverage specialized computing devices (e.g., mobile devices with location sensors; inertial sensors; physical activity monitoring capabilities; digital communication behavior-monitoring capabilities; and/or other non-generalized functionality) in collecting supplemental data that can be used to provide additional context and/or insights associated with user metrics. The technology can, however, provide any other suitable benefit(s) in the context of using non-generalized computer systems for improving workplace-related data processing.

### 3. System

Embodiments of a system 200 for improving user metric determination associated with a workplace can include: a client system 210 (e.g., an application executable on a user device) configured to collect user data (e.g., user responses to digitally presented queries surveying the user in relation to the workplace) and a metric system 220 configured to determine user metrics for users associated with the workplace. Additionally or alternatively, embodiments of the system 200 can include user devices and/or any other suitable components.

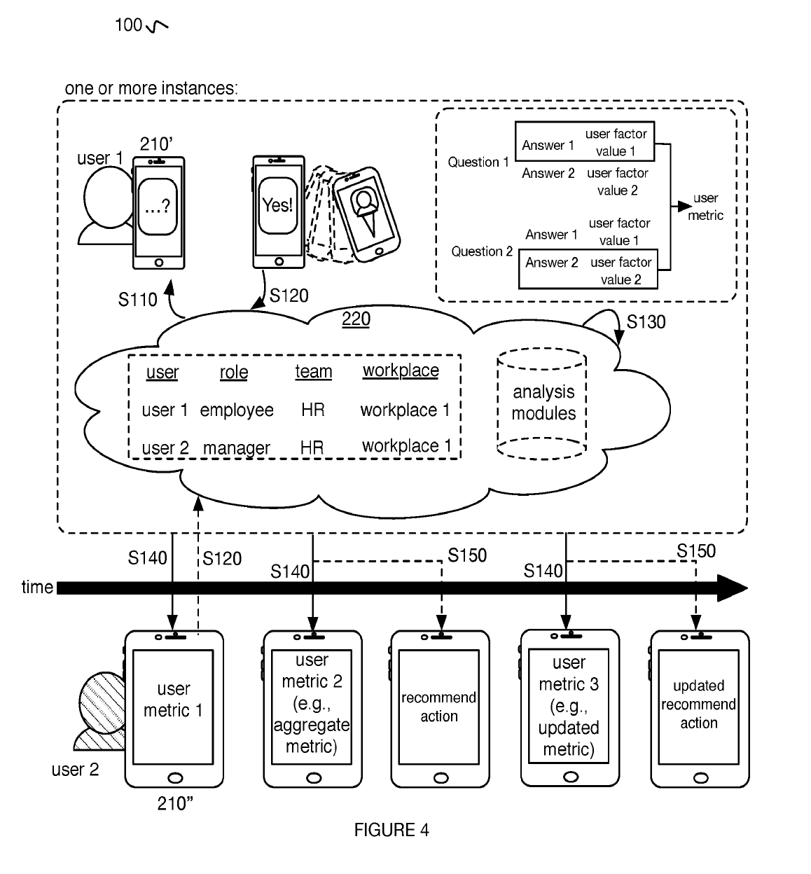

The system 200 can include one or more client systems 210, which can include one or more user interfaces. The client systems 210 can function as interfaces between users and the metric systems 220. For example, as shown in FIG. 4, the system 200 can include a first and a second client system 210′, 210″ associated with a first and a second user, respectively, but client systems 210 can be associated with any suitable number of users. The client systems 210 can present queries, metrics, recommendations, and/or other associated user data to a user to improve display of data through the user interface; receive query responses and/or other suitable user inputs from the user; receive device data from a host user device (e.g., sensor data, location data, etc.); control logins (e.g., user account login); process user inputs; encrypt user inputs and/or processed information; control data communication (e.g., transmission to the metric system 220, receipt, retrieval, request, etc.), control user device operation (e.g., notifications, sensor operation, etc.), and/or perform any other suitable functionality.

The client system 210 preferably runs (e.g., executes) on a user device, but can alternatively run on any other suitable computing system. The client systems 210 can be a native application, a browser application, an operating system application, and/or be any other suitable application or executable. Examples of the user device can include a tablet, smartphone, mobile phone, laptop, watch, wearable device (e.g., glasses), or any other suitable user device. The user device can include power storage (e.g., a battery), processing systems (e.g., CPU, GPU), user outputs (e.g., display, speaker, vibration mechanism, etc.), user inputs (e.g., a keyboard, touchscreen, microphone, etc.), a location system (e.g., a GPS system; location sensors; etc.), sensors (e.g., optical sensors, such as light sensors and cameras, orientation sensors, such as accelerometers, gyroscopes, and altimeters, audio sensors, such as microphones, environmental sensors, such as temperature sensors, biometric sensors, such as heart rate monitors, etc.), data communication system (e.g., a WiFi module, BLE, cellular module, LAN connections, etc.), and/or any other suitable component, where data associated with the components can be collected (e.g., in the form of a query response) for processing with the method 100. However, such components can be included in any suitable portion of the system 200.

In a variation, the client system 210 (and/or other suitable component such as the metric system 220) can be configured to modify a perceptible digital element associated with user data and/or other suitable data for improving display (e.g., of queries; of user metrics; of query responses; etc.) through the user interface. Modification of perceptible digital elements can include modification of any one or more of: content modifications (e.g., expressing the content in a manner personalized to the user and/or associated workplace role, such as in relation to language, characters used, associated media, colors, etc.); textual parameters (e.g., text-based communications; font size; font color; font type; other font parameters; spacing parameters; etc.); graphical parameters (e.g., communications including images, video, virtual reality, augmented reality, etc.); other parameters associated with perceptible digital elements (e.g., sizing, highlighting, etc.); audio parameters (e.g., audio-based communications such as through music, sound notifications, a human voice, an intelligent virtual assistant; volume parameters; tone parameters; pitch parameters; etc.); touch parameters (e.g., braille parameters; haptic feedback parameters; etc.); delivery-related parameters (e.g., selection of user device for presentation of user data, such as through mobile device versus laptop); and/or any other format-related parameters. In a specific example, the system 200 can be configured to modify perceptible digital elements associated with queries (e.g., modifying the background color associated with the queries) presented to a user (e.g., at a daily check-in), such as based on workplace role (e.g., selecting different background colors for an engineering team versus an operations team, etc.), historic user metrics (e.g., selecting a green background color in response to a historic user metric indicating low engagement, etc.), and/or other suitable criteria, but any suitable digital element associated with any suitable data can be modified based on any suitable criteria and/or for any suitable goal. Additionally or alternatively, improvement of information display can be performed in any suitable manner. However, the client system 210 can be configured in any suitable manner.

The system 200 can include one or more metric systems 220, which can function to process user input to generate one or more user metrics. User metrics can include: communication, teamwork, execution, relationships, expertise, leadership, creativity, flexibility, work stress management, perseverance, morale, company connection, project sentiment, priorities, concerns, accomplishments, risk factors (e.g., attrition risk, low user metric value risk, etc.), predicted future user metrics, performance of workplace actions (e.g., likelihood of performing a recommended action), usage of the client system 210, and/or any other suitable metric. User metrics can additionally or alternatively include aggregate user metrics generated based on constituent user metrics and/or user factors. User metrics can additionally or alternatively include job and workplace role specific metrics (e.g., specific to a role identifier), such as metrics specific to engineering, sales, negotiation, and/or other suitable skills. Aggregate user metrics can include: performance, engagement, alignment, summary data (e.g., graph, chart, user metric comparisons, etc.) and/or any other suitable aggregate metrics. In one example, performance can be determined based on: communication, teamwork, execution, relationships, expertise, leadership, creativity, flexibility, work stress management, perseverance, collaboration, getting things done, handling stress, overcoming obstacles, problem solving, and reliability; engagement can be determined based on: morale and company connection; and alignment can be determined based on: project sentiment and also the feedback provided by managers and peers to specific queries answered by users reporting to them (e.g. queries regarding employee priorities, concerns, and achievements, etc.). In a specific example, a manager can be prompted to provide a response to a presented user metric, where the response can be used in determining alignment (e.g., a response of “I agree” would positively influence an alignment metric, and a response of “I disagree” negatively influence an alignment metric; etc.). In another specific example, the manager response (and/or lack of any response) can be used to modify metrics of the manager (e.g., such as in relation to their management performance, etc.). User metrics are preferably associated with a workplace (e.g., describing users in relation to a workplace environment), but can additionally or alternatively be associated with any suitable entity. However, user metrics can be otherwise configured.

The metric system 220 preferably includes one or more analysis modules, which preferably include query models (e.g., for determining queries, etc.) and/or metric models (e.g., for determining metrics; for extracting user factors, such as from query responses, where user metrics can be determined based on the user factors; etc.), but can additionally or alternatively include workplace action models (e.g., for determining workplace actions; a recommendation model for determining recommendations; etc.), and/or any other suitable models. The analysis modules can be global, per employee, per user, per user set (e.g., team, company, etc.), or for any other suitable set of users. The analysis modules are preferably applied (e.g., generated, trained, executed, stored, updated, etc.) as a component of the metric system 220, but can additionally or alternatively be applied at user devices. The metric system 220 preferably includes a remote metric system 220 (e.g., a remote server system), but can additionally or alternatively include: networked user devices, and/or any other suitable computing system. The remote metric system 220 can be stateless, stateful, and/or include any other suitable configuration and/or property.

In a first variation, the metric system 220 can include a single analysis module (e.g., a convolutional neural network, a rule-based system, etc.) for generating outputs (e.g., using the same analysis module across users, etc.). In a second variation, the metric system 220 can include a plurality of analysis modules that can generate different data based on individual users, workplace role (e.g., employee, manager, leadership, etc.), teams, projects, workplaces, and/or any other suitable parameter. The parameters (e.g., roles, hierarchy, teams, projects, etc.) can be: received from a user (e.g., a managing entity, such as a project manager, a team manager, human resources, etc.), automatically determined (e.g., based on names mentioned in the user responses, historical user device collocation durations, event invitees, etc.), and/or otherwise determined. In a third variation, the metric system 220 can include multiple analysis modules that each generate a probability or score for a given metric, where a second set of analysis modules can take the output from the primary set of analysis modules to generate outputs for a given user type. In one example, a first set of analysis modules can calculate metrics (e.g., score) for one or more of: communication, teamwork, execution, relationships, expertise, leadership, creativity, flexibility, work stress management, perseverance, impact of achievements, quality of work, and/or level of difficulty of an achievement, while a second set of analysis modules can process the outputs from the first set of analysis modules to calculate an aggregate metric (e.g., score) for user performance, adaptability, achievements, and/or other suitable metrics. In a second example, a first set of analysis modules can extract factor values (e.g., user features, signals) from user responses to the queries, social networking systems, social validation (e.g., validation constructs) received from other users and/or the metric system 220), and/or any other suitable data source; a second set of analysis modules can determine user metrics (e.g., scores for engagement, alignment, performance, capability, etc.) based on the output of the first set of analysis modules (e.g., including the “weight” of the other user, which can be determined by their standing in a workplace and/or their expertise in the area that they provide feedback about, etc.); and a third set of analysis modules can predict recommendations (e.g., employee actions) based on the outputs of the first set and/or second set of analysis modules. However, the metric system 220 can include any suitable number of analysis modules, connected in any suitable manner, that perform any suitable functionality.

Each analysis module can utilize one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), backward chaining, forward chaining, and any other suitable learning style. Each module of the plurality can implement any one or more of: a rule-based system, a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm. Each module can additionally or alternatively include: probabilistic properties, heuristic properties, deterministic properties, and/or any other suitable properties. However, analysis modules can leverage any suitable computation method, machine learning method, and/or combination thereof.

Each module can be validated, verified, reinforced, calibrated, and/or otherwise updated based on newly received, up-to-date user data; historic data for the user; data for other user; and/or be updated based on any other suitable data. In one example, the method 100 can include recommending a user action using a recommendation model based on historic data for a user, determining performance of the recommended action (e.g., receiving confirmation from the user of completion of the recommended action, etc.), monitoring user metrics for the user for a period of time, and evaluating the success (e.g., effectiveness for improving a user metric) of the recommended action. The recommendation model can be reinforced (e.g., using the historic data and recommended action) in response to recommended action success, and retrained (e.g., using the historic data and recommended action) in response to recommended action failure. In a first specific example, the metric system 220 can be configured to: identify a skill weakness (e.g., a user metric value below a threshold determined from an average metric value for other members of the user's team, etc.) for a user based on the user's historic data; recommend a skill development action to the user (e.g., scheduling a skill-building course for the user; scheduling a meeting with the user's manager; etc.); track the user's data associated with the skill (e.g., peer comments; validation constructs; query responses; etc.) over a period of time; and query the user and/or peers to determine whether the user has improved on the skill. However, the skill weakness, skill development action, and/or any other suitable information can be received from a user (e.g., the user or a second user). In a second specific example, the recommendation module can be automatically reinforced when the user improved on the skill (e.g., where the same action can be recommended to other users with the same skill deficit and/or user profile, etc.), and can be retrained when the user did not improve on the skill (e.g., where the same action is not recommended to other users with the same skill deficit and/or user profile, etc.). However, modules can be updated in any other suitable manner.

Each module can be applied (e.g., executed, updated, etc.): once; at a predetermined frequency; every time the method 100 is performed; in response to satisfaction of a condition (e.g., determination of an actual result differing from an expected result); every time an unanticipated measurement value is received; and/or at any other suitable time and frequency. The set of modules can be applied concurrently with one or more other modules, serially, at varying frequencies, and/or with any suitable temporal relation to other modules and/or portions of the method 100. Additionally or alternatively, analysis modules and/or other components of the metric system 220 can be configured in any suitable manner.

The system 200 can additionally or alternatively include a set of user accounts (e.g., each representative of a user, etc.), which can function to identify users in accounting (e.g., storing, retrieving, updating, etc.) for user data. The user accounts can each be associated with a set of user metrics, which are updated dynamically, based on the respective user's responses to the queries, the validation constructs received by the user, and/or based on any other suitable information. The user metrics can additionally degrade over time (e.g., at a predetermined rate, in response to the occurrence of a predetermined event, etc.), and/or be otherwise adjusted as a function of time. The user metrics can be used to: identify user progress (e.g., in a metric), identify potential user issues, assign users to projects, assign users to teams, generate recommended actions (e.g., for the user or for secondary users), and/or used in any other suitable manner. However, user accounts can be associated with any suitable data (e.g., personalized queries, user metrics, recommendations, etc.), and/or can be configured in any suitable manner.

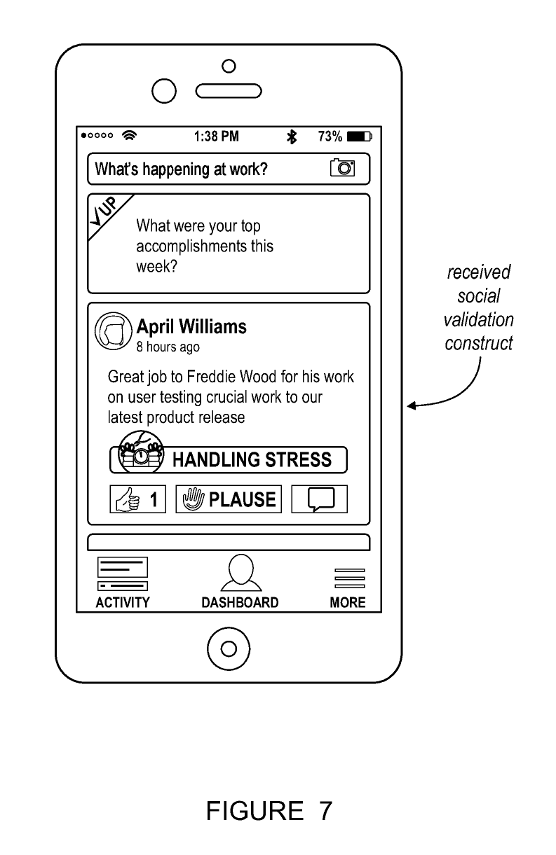

The system 200 can additionally or alternatively include one or more validation constructs (e.g., endorsements, “kudos”, “likes”, etc.), which can function as recognition of a user's skillset, user metric progress, achievement, and/or other suitable event associated with the user (e.g., as shown in FIG. 7). In a first variation, the metric system 220 can be configured to automatically provide a validation construct to a user based on metrics and/or other suitable data (e.g., using a validation construct model, etc.). In a second variation, users can transmit validation constructs to other users. In an example, a second user can “give” (e.g., post, send, etc.) a validation construct to a second user, a set of users (e.g., involved with a project), and/or other suitable entity. The validation construct can include user-generated content (e.g., a comment). The validation construct can be associated with an auxiliary data construct (e.g., a project, task number), where the auxiliary data construct can be within the same system as the validation construct or be an external system (e.g., third party system). Each validation construct can be associated with one or more user factors or metrics. The user creating the validation construct can have the opportunity to specify values for those metrics as to give an indication of the level of achievement. In a specific example, user-generated content can be processed by natural language systems to infer the content and/or context of the validation construct. This context and/or content can be subsequently used to validate the metrics associated with the validation construct, used to infer the impact of the user on the project associated with the validation construct, and/or used in any other suitable manner. Each user can be limited to sending a predetermined number of validation constructs for a period of time, or can send an unlimited number of validation constructs to any suitable number of users. Additionally or alternatively, validation constructs can be configured in any suitable manner. However, the system 200 can be configured in any suitable manner.

### 4. Method

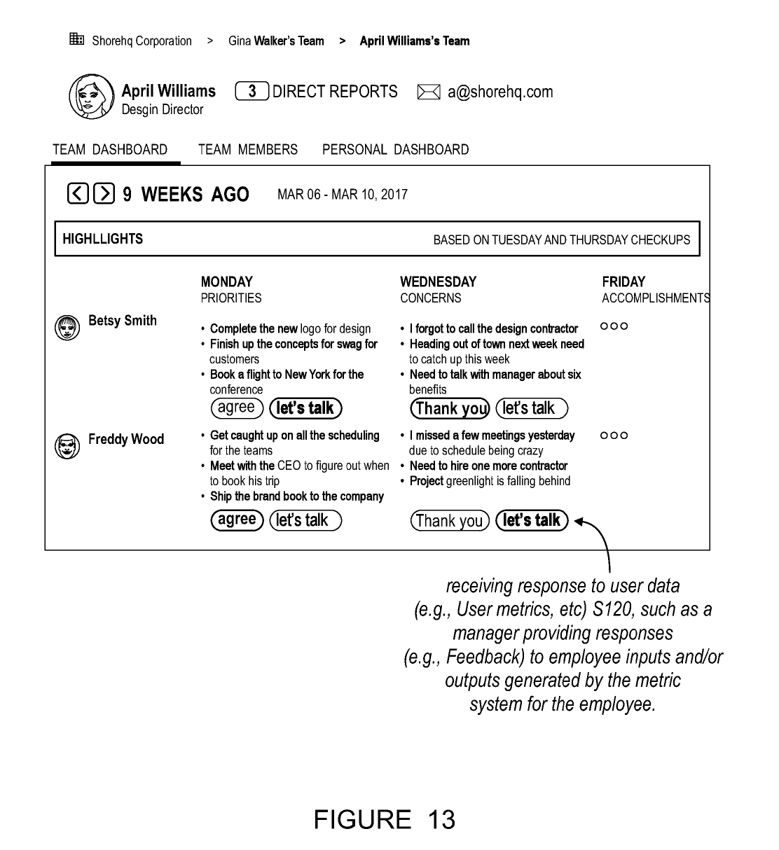

Presenting a query to a first user based on a role identifier identifying a workplace role for the first user S110 can function to prompt the user to input information for subsequent analysis. Presenting the queries can optionally include determining queries and/or any other suitable process associated with presenting queries. The queries preferably solicit information (e.g., user data) regarding users (e.g., themselves or others), but can additionally or alternatively function to obtain data regarding any suitable aspect associated with the workplace (e.g., data regarding user metrics, the client system, the queries themselves, etc.). Queries preferably include questions (e.g., “how engaged do you feel with your current project?”; etc.), but can additionally or alternatively include statements (e.g., “describe how you felt about the project over the last week”; etc.), user metrics (e.g., where users can respond to the user metrics, such as through signaling agreement or disagreement with a user metric; such as through indicating a need for future communications in response to presented priorities and/or concerns, as shown in FIG. 13; etc.), media (e.g., images, video, virtual reality, augmented reality, etc.), audio (e.g., queries spoken by a virtual assistant; music; etc.), data requests (e.g., API requests for user data; requests transmitted to user devices, to client systems, third party databases such as social network-related databases; etc.), and/or any other suitable information associated with data collection. The queries can typify one or more query types. In a first variation, the query can be a multiple choice question and/or binary question (e.g., yes/no), where a user selects one or more of a predetermined set of answers. In a second variation, the query can be a free-answer question, where the user uses a set of tools (e.g., keyboard, drawing pad, etc.) to answer the question. In a third variation, the query can be a task, where the user answer includes solving the task or performing a series of actions according to the task instructions. However, queries can typify any other suitable query type.

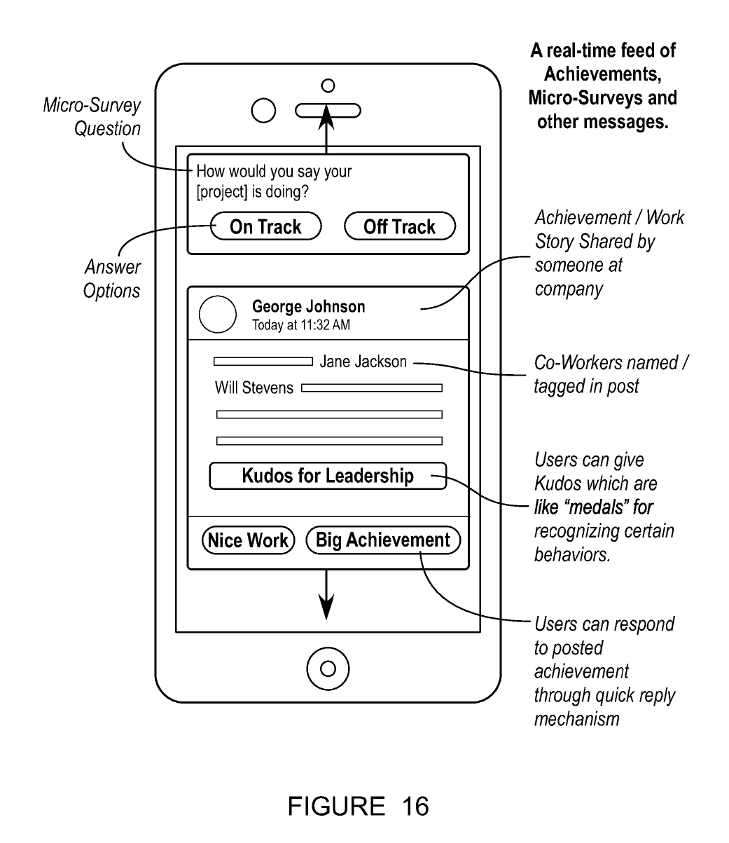

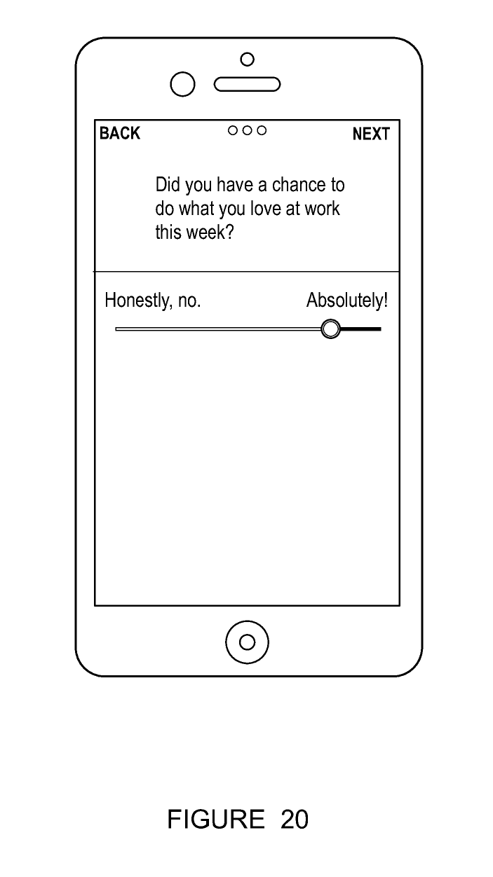

Queries are preferably presented at client systems, but can be presented in any suitable manner. In a first variation, as shown in FIGS. 16 and 20, the queries are presented through a set of notifications generated by the client systems, where the subsequent user responses can be received through the notification. In a second variation, presenting the query set can include: generating a notification by the client systems, where notification selection launches the client systems and presents the query set. In a third variation, the queries are presented when users view validation constructs and select to perform a “review”. However, the query set can be otherwise accessed. When the query set includes multiple queries, each query can be presented as a separate card (e.g., where new cards appear as queries are answered), or be presented on the same card (e.g., where the user scrolls down to answer the next query). However, the queries can be otherwise presented.

Each query can be associated with one or more user factors (e.g., factor values from which user metrics can be determined; features correlated with user metrics; etc.), user metrics, and/or associated with the sub-dimensions and/or measurable behaviors that can make up the user factors and/or user metrics (e.g., based on nomological networks). The query is preferably configured to solicit information from which user factors can be extracted, but can additionally or alternatively be configured to solicit any suitable information. The user factors (and/or user metrics determined from the user factors) can be updated based on new query responses, in response to satisfaction of a condition (e.g., receiving a threshold number of query responses from a user; elapsing of a time condition; etc.), and/or at any suitable time and frequency. When the query set includes multiple queries, each query within the set is preferably associated with a different set of user factors and/or user metrics. The user metric set associated with each query is preferably separate and discrete from the user metric set associated with the other queries (e.g., presenting a set of queries on Monday to evaluate performance; presenting a separate set of queries on Tuesday to evaluate engagement; etc.), but can alternatively overlap, coincide, and/or be otherwise related. The queries can be associated with a query type, tone, difficulty, role, project, team, and/or any other suitable data. The data associated with the queries can be stored in metadata associated with the query and/or can otherwise be processed in relation to the queries. However, queries can be associated with any suitable data in any suitable manner.

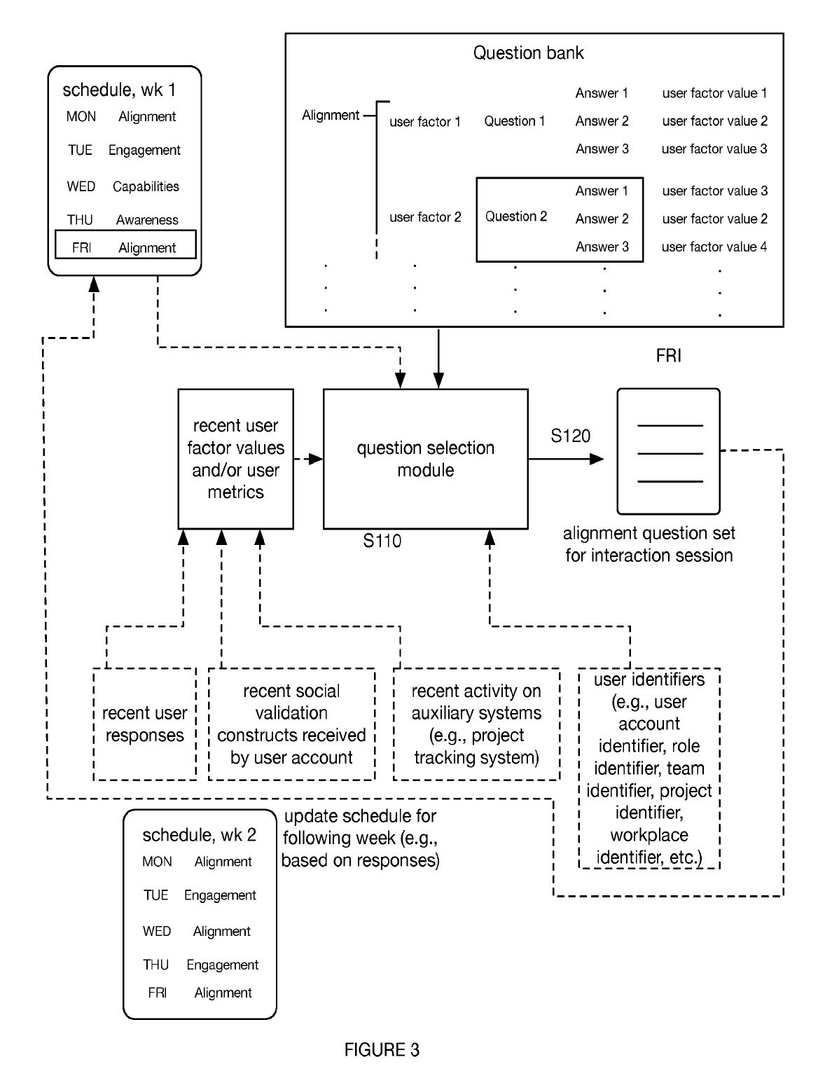

The queries are preferably presented at a predetermined frequency (e.g., presenting different queries on different days of a work week, as shown in FIG. 3; etc.), but can additionally or alternatively be presented in response to the satisfaction of a condition (e.g., a user metric satisfying a threshold condition; receipt of a manual request from a manager to present a query to a team member; presentation trigger events, etc.), and/or be presented at any other suitable time and frequency. Examples of the predetermined frequency include: every day at a predetermined time, every weekday morning at a predetermined time (e.g., 9 am), every 24 hours, or any other suitable frequency. Examples of additional conditions that can trigger query presentation can include: viewing of achievements and kudos, meeting termination (e.g., as determined based on user device orientation sensor data, calendar data, user device location data, etc.), client systems launch, or any other suitable event. In a first variation, presented queries can be associated with time conditions. In a first example, the queries can expire (e.g., where a user is restricted from answering the query) after a threshold period of time (e.g., after a day), expire after satisfaction of a condition (e.g., when an associated project is marked “done”), and/or expire at any suitable time. In a second example, queries can be activated according to time conditions (e.g., where the user is allowed to answer the query starting on Tuesday, and can preview the query starting on Monday, etc.). In a second variation, queries can remain available until the user answers the query. However, queries can be presented in any suitable temporal manner.

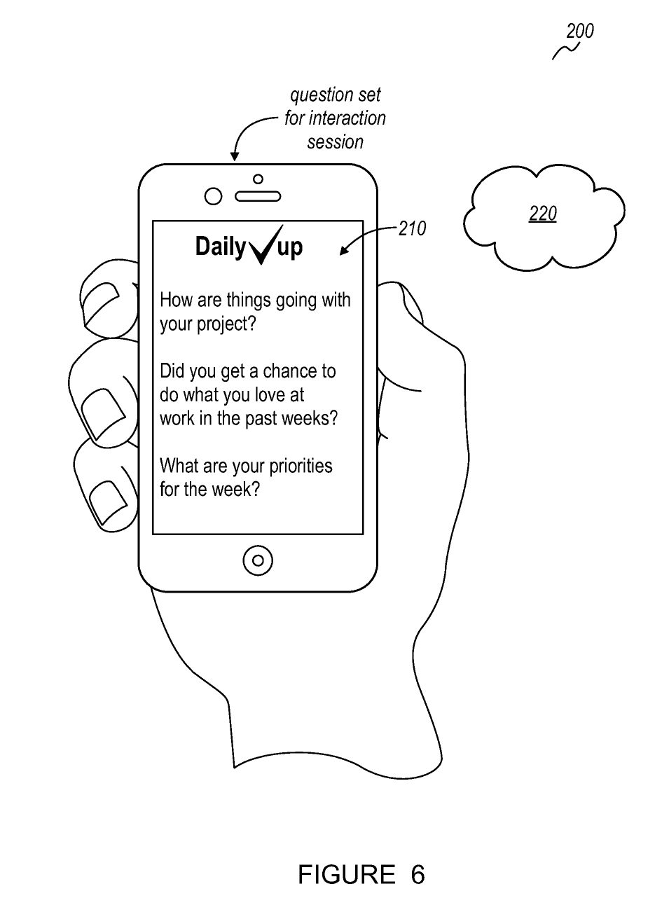

The set of queries is preferably presented by the client systems at a user device (example shown in FIG. 6), but can alternatively be presented by any other suitable system component. Different queries are preferably presented at the client systems in different interaction sessions, but the same queries or overlapping queries can alternatively be presented across different interaction sessions. Multiple queries are preferably presented at the client systems concurrently or in succession (e.g., during the same interaction session), but single queries can alternatively be presented during an interaction session. In one example, only three queries are presented at the client systems for a predetermined period of time (e.g., three queries per day). However, any suitable number of queries can be presented during an interaction session.

Presenting queries preferably includes determining queries for presentation to users. Determining queries can include: generating queries; selecting queries (e.g., a subset of the generated queries); updating generation and/or selection processes for queries (e.g., through reinforcement learning; etc.); storing queries in association with user data (e.g., user identifiers such as an user account identifier, role identifier, team identifier, project identifier, workplace identifier, etc.), and/or other suitable data; retrieving queries based on associations; and/or any other suitable processes. The determined queries can be generic (e.g., across a first user population, across all user populations, etc.), specific to a user set, specific to a user (e.g., specific to a user account), or otherwise targeted. Determining queries can be based on: user identifiers, workplace role associated with the user, a query schedule (e.g., configured to evaluate different user metrics as dynamically updatable time periods; query presentation frequency; etc.), user history (e.g., communications between users; validation construct usage history; etc.), historical user responses, user factors (e.g., temporal features such as average, estimated, median query response time, etc.) and/or user metrics associated with the query, associated query parameters (e.g., query length, popularity, etc.) and/or other suitable criteria.

In a first variation, the method 100 can include determining a query and/or a time condition for a user based on a role identifier identifying a workplace role associated with the user. In a first example, a first set of queries associated with engagement can be selected for presentation to members of a team, and a second set of queries associated with alignment can be selected for presentation to a manager of the team. In a second example, the method 100 can include: setting a time condition requirement (e.g., within a week) for a user to answer the query based on the user's role as a member of a team, where the manager of the team has specified a time preference for receiving a report on the team members (e.g., weekly reports). In a third example, determining a query can include adjusting a time condition for a query based on the role identifier (e.g., setting a shorter time requirement for an user to answer a query than for a manager to answer the query; etc.). In a fourth example, the method 100 can include: storing a query in association with a time condition and a role identifier (e.g., storing a query of “Is there an open channel of communication with your manager?” in association with a role identifier of employee managed by the manager); and selecting the query for a user identified by the role identifier. In a fifth example, determining queries can be based on associations between role identifiers for the workplace (e.g., selecting the same set of queries to present to members of a first team and a second team, where the responses can be used to determine user metrics comparable across teams to be able to present to a manager of the first and second teams; etc.).

In a second variation, the method 100 can include determining a second query and/or a time condition for a user based on a response to a first query (e.g., by the user, by another user, etc.). In a first example, determining queries can include updating a future query schedule based on user metrics determined from queries presented in a current time period (e.g., updating a future query schedule to include additional engagement-related queries in response to determining an engagement score below a threshold value for the current time period). In a second example, determining queries can be based on a manager's response to presented user metrics (e.g., describing members of the manager's team, etc.), such as selecting alignment-related queries based on a manager's response of “I disagree” to a presented user metric. In a third example, determining queries can include selecting queries based on probability that the user will answer the queries (e.g., selecting queries based on user preferences for query types, as indicated by historical user responses; etc.). However, determining queries can be based on any suitable data in any suitable manner.

The queries can be determined at a predetermined frequency (e.g., at the same or similar frequency as query presentation; be determined at a different frequency, such as once a month; etc.), determined upon satisfaction of a condition (e.g., a user metric value below a threshold metric value; etc.), and/or determined at any other suitable time. The queries can be determined: automatically, manually, pseudo-manually, or in any other suitable manner by any other suitable determination mechanism. However, the queries can be determined in any suitable manner.

Determining queries can optionally include generating queries, which can function to provide a query database (e.g., as part of the metric system), from which queries can be selected. In a first variation, the queries are manually generated. In a second variation, the queries are automatically generated based on a set of user factors and/or parameters. In a first embodiment of the second variation, the method 100 can include: training a query generation module using a supervised training set and generating queries associated with the user factor set using the trained query generation module. The supervised training set can include a set of manually generated queries, each query associated with its own user factor set (e.g., the queries from the first variation), or include any other suitable data. natural language processing (NLP) methods and/or any other suitable process can be used to analyze the training queries and/or generate queries. In a third variation, the queries can be pseudo-automatically generated. For example, a query template can be manually generated, where the system automatically fills out the query template. In a specific example, the system can fill in a “coworker name” variable with the name of a coworker, where the user's response to the query is used to determine the metrics for the coworker. However, the queries can be automatically generated in any other suitable manner.

Determining queries can optionally include selecting queries, which can function to identify a subset of queries (e.g., a predetermined number of queries, predetermined predicted duration for responding to the queries, etc.) from the query database for presentation to a user. In one variation, the queries are selected according to a predetermined user factor schedule. For example, a query associated with alignment factors can be selected for Mondays, a query associated with engagement factors can be selected for Tuesdays, a query associated with capability or performance can be selected for Wednesdays; a second query for Wednesdays could be associated with alignment factors; a query associated with awareness factors can be selected for Thursdays, and a query associated with alignment factors, such as the achievements made in the current work week, can be selected for Fridays. In this example, the alignment query on Monday can be used to set priorities for the week (e.g., task priorities, etc.), while the same or similar alignment query on Wednesday can be used to identify any priority issues, which can be addressed over the remainder of the week. However, the user factors can be scheduled in any other suitable manner.

In a second variation, the query can additionally or alternatively be selected for a user subset or individual users (e.g., selecting different queries for different types of user identifiers, such as selecting different queries for a team member versus a manager of the team, etc.), which can function to tailor queries toward the user. In a first example of the second variation, the query is selected based on the user's response history. In a first example, a first query type can be preferred for a user over a second query type, based on the respective response frequencies. In a specific example, multiple choice questions can be preferentially selected for a user when the user answers 90% of any multiple choice question posed, but skips 80% of the free answer questions posed. In a second example, a first query (associated with a first set of user factors) can be selected over a second query (associated with a second set of user factors) when a third query, similar to the second query (e.g., associated with a set of user factors similar to the second set), was recently presented to the user. Alternatively, the first query can be selected over the second query when the user skipped a fourth query, similar to the first query (e.g., associated with a fourth set of user factors similar to the first set) during a prior interaction session. However, the query can be otherwise selected based on the user's response history.

In a second example of the second variation, the query can be selected based on the user's peers' response history. For example, a query can be selected to verify a trend detected in a coworker's metrics and/or user factors. In a specific example, the method 100 can include: detecting a negative trend in a second user's metrics (e.g., negative engagement), selecting a query associated with the metric for a first user in response to negative trend detection (e.g., selecting an engagement question for the user), and analyzing the response to determine whether the trend is a pervasive trend, or is isolated to the second user (e.g., whether the entire team is down in engagement, or if only the second user is down in engagement; etc.). In a second specific example, the method 100 can include: detecting a positive trend in a second user's metrics (e.g., capability gain), selecting a query associated with the metric and the second user (e.g., querying the first user as to whether they think the second user has experienced a capability gain), and analyzing the response to verify the trend. However, the query can be otherwise used. In a third example of the second variation, the query can be selected based on the user's personalized user factor schedule. The personalized user factor schedule can be automatically generated (e.g., learned, based on historical user responses), manually generated (e.g., set by the user or a different user, such as a manager), dynamically determined (e.g., based on the first and/or second examples), or otherwise determined.

In a fourth example of the second variation, the query can be selected based on the users' auxiliary signals, generated from auxiliary sources. The auxiliary sources can include: validation constructs offered by the system (e.g., stickers, kudos, achievements, likes, notes, etc.); signals extracted from secondary systems, such as external social networking systems, planning systems (e.g., Kanban programs), project and/or issue tracking systems (e.g., Jira™), or any other suitable system; or be generated from any other suitable data source. In a first specific example, the queries are selected based on the user metrics determined from the auxiliary scores. In a second specific example, the auxiliary signals can be user factor scores or metric scores (e.g., where the source data is processed by a signal determination module to extract information indicative of user factors), can be scored for each user factor, or can be otherwise determined. In a third specific example, the auxiliary signals can be auxiliary factors associated with one or more user factors or metrics, where the user factor scores can be determined based on the auxiliary signals. In a fourth specific example, the auxiliary signals can be indicative of (e.g., correlated with) an event (e.g., a life event, a workplace event, etc.), which can be associated with increased engagement and performance. The queries can be selected to verify this increase (e.g., by selecting queries directed toward engagement and performance). Alternatively, the queries can be selected to determine values for other user factors (e.g., where the user metrics determined from the auxiliary signals are used in lieu of the user metrics that would have been determined from the queries). In a third variation, the queries are selected randomly. In a fourth variation, the queries are selected by a user (e.g., manually). In a fifth variation, all users of an organization, a team, and/or other groups, can get the exact same query on a specific day in order to allow for a group analysis of the response (e.g. to get an overview of the mood of a team and/or determine any suitable group-specific aggregate metric, etc.). However, the queries can be otherwise selected, and presenting queries can be performed in any suitable manner.

Collecting a response to the query from the first user S120 can function to obtain a response from which user metrics can be determined (e.g., through extracting user factors from the response). Responses are preferably collected from users (e.g., who input the response at a client system executing on a user device), but can additionally or alternatively be collected directly from devices (e.g., without input from a user, such as when collecting sensor data from a user device through a data request query transmitted from the metric system and/or client system to the user device; collecting responses to database queries; etc.) and/or other suitable entities. The user response can include: a selection of an answer from a predetermined set of answers (e.g., an answer to a multiple choice question), selecting a value from a range (e.g. a “star rating”), a text input, a graphical input (e.g., an image of the user's face; a selection of a graphic from a set of graphics; etc.), an audio input (e.g., voice), a drawing input, a data request response (e.g., a response to an API request; data retrieved from a database in response to a database query; etc.), responses possessing any suitable format-related parameters, and/or any other suitable response to a user query. In a first example, collecting a response can include collecting location data (e.g., associated with a user's answer to a query; etc.) sampled at one or more location sensors (e.g., of a user device executing the client system; etc.) associated with the first response and sampled at a location sensor of a user device executing the first client system. In a second example, collecting a response can include collecting inertial sensor data (e.g., associated with a user's answer to a query; indicative of physical activity and correlated with user metrics such as performance; etc.). In a third example, collecting a response can include collecting a response to a first user metric (e.g., agreement with the metric; scheduling an action item, such as “let's talk”, associated with the user metric; etc.), where the response can be used to determine a second user metric (e.g., alignment; engagement; etc.).

Collecting responses preferably includes collecting responses in accordance with one or more response conditions. In a first variation, collecting responses can be in accordance with a time condition. For example, the method 100 can include collecting responses to queries before a time condition (e.g., a time requirement before the query expires), which can be determined based on timing preferences (e.g., received by a manager and/or other suitable user). However, collecting responses can be performed at any suitable time and frequency dependent or independent from time conditions. In a second variation, collecting responses can be in accordance with a data type condition (e.g., requiring specific queries from a set of queries to be answers; requiring a specific response format for a query; etc.). However, collecting responses can be based on any suitable conditions, can be performed in any suitable manner.

Determining a metric for the first user based on the response to the query S130 can function to determine user metrics describing one or more users in relation to a workplace. Determining user metrics can additionally or alternatively include: determining user metrics with a metric model; determining summary data (and/or other suitable aggregate metrics); pre-processing user data; selecting user metrics (e.g., from a predetermined set of user metrics; etc.); updating user metrics (e.g., over time based on additional query responses, such as shown in FIG. 4, etc.); and/or any other suitable processes.

Determining a user metric is preferably based on one or more query responses, such as based on user factors extracted from the query responses. Types of user factors include: content features (e.g., multiple choice options for a query, where each option can be associated with different user metrics and/or different values of a user metric; types of responses that can be input for the query, such as allowing freeform text versus requiring a multiple choice selection; combination of responses across multiple queries, such as over multiple interaction sessions or within a single interaction session; etc.); textual features (e.g., word frequency, sentiment, punctuation, length, associated with the queries and/or associated responses; etc.), graphical features (e.g., emojis used in query responses; optical sensor-captured data; media posted to social networking sites; media transmitted and/or received through digital messages facilitated by the client systems; associated pixel values; etc.), audio features (e.g., Mel Frequency Cepstral Coefficients extracted from audio captured in a response to a query; audio features associated with an audio query, such as gender of audio speaker, tone, volume; etc.), historical features (e.g., previous user responses to the query type and/or similar queries; historical validation constructs communicated between the query recipient and another user related to the query, such as an individual who the query recipient is rating; etc.), role features (e.g., role relationship between the query recipient and the user, such as employee-manager, manager-supervisor, peer-peer, etc.), contextual features (e.g., location features associated with the query, such as location at which the query is scheduled to be transmitted; location of the user when the user responds to the query; inertial sensor data indicative of a user's level of physical activity and/or sleep patterns, which can be correlated with performance and/or engagement; physiological features such as biometrics from a wearable device, shaking, sighing, laughing, emotion analysis, facial expression; auxiliary sensor data such as sensor data sampled at a sensor of an adjacent building fixture, at a sensor at the workplace; etc.), temporal features (e.g., scheduling of the query, such as scheduling of different types of queries for different work days, where scheduling can be based on evaluation of different user metric types; length of time between presenting a query and receiving a response, which can be correlated with engagement; frequency at which a user responds to a query; time to respond to different types of queries; etc.), and/or any other suitable user factors.

In a first specific example, determining a user metric can include extracting content features (e.g., positive sentiment) for a query (e.g., regarding a current project) based on natural language processing of text content of the query; and determining a user metric (e.g., high engagement; an addition of predetermined amount of points to an engagement score; weighting the metric based on the user role; etc.) based on the content features. In a second specific example, as shown in FIG. 3, the method 100 can include: generating a query (e.g., “do you agree with your team's performance score?”, etc.) with a predetermined set of potential responses (e.g., “yes”, “no”, etc.); associating (e.g., at a query database) a factor value (e.g., different factor values) to each potential response of the set of potential response (e.g., “yes” corresponding to an increase of 2 points in alignment score; “no” corresponding to a decrease of 2 points in alignment score; etc.); receiving a query response; and mapping the query response to the corresponding factor value. In a third specific example, the method 100 can include presenting a first query (e.g., a first user metric describing an employee associated with a team) to a user (e.g., a manager of the team) at a first time period; receiving a response (e.g., “let's talk”, “I agree”, “I disagree”, etc.) to the query from the user at a second time period after the first time period; and generating a metric (e.g., an engagement score describing the manager) based on the response and the first and second time periods. In a fourth specific example, the frequency of how managers provide “agreement” or “disagreement” feedback to their reports (e.g., presenting user metrics) can be used to understand the alignment between users and/or to determine how engaged the manager is with the workplace (e.g., where if a manager does not provide feedback to their employees on a frequent basis, a low engagement score can be determined for the manager and/or reported to a supervisor of that manager; etc.). Additionally or alternatively, factor values can be extracted from auxiliary sources (e.g., validation constructs, role identifiers, other user data, etc.), and/or any other suitable sources. However, determining user metrics based on user factors can be performed in any suitable manner, and determining user metrics can be based on any suitable data types and/or combinations thereof.

In a first variation, determining a user metric can be based on validation constructs. For example, the work stress management score for the first user can be increased when the validation construct is associated with work stress management. The work stress management score for the first user can additionally or alternatively be increased based on the comment associated with the validation construct. For example, the score can be increased when the comment is unique (e.g., locally unique, indicating that the sending user generated the comment themselves), when sentiment analysis indicates awe or appreciation, when the comment is over a predetermined length, or based on any other suitable comment parameter. Additionally or alternatively, the validation construct can be shown to third users who can provide their own user metrics through responding to queries associated with the validation construct, general agreement (likes, +1), and specifying user metrics directly (“star rating”). In a first specific example, user metrics can be extracted from a second validation construct (“achievements”) presented by a first user to a second user, where the user metrics are stored in association with the first user. The second user can respond by providing their own user metrics through responding to queries associated with the validation construct, general agreement (likes, +1), and specifying user metrics directly (“star rating”). In a second specific example, users such as line managers and/or project managers can provide private or public validation (e.g., with a validation construct) and/or feedback (e.g., indicating a degree of agreement or disagreement) to the first user (e.g., who is reporting to the manager), which can be used to determine alignment (e.g., between users, teams, workplaces, etc.), to set and/or track performance goals, personal development goals and/or other kinds of performance management metrics, and/or determine any suitable user metrics. However, determining user metrics based on validation constructs can be performed in any suitable manner.

In a second variation, determining a user metric can be based on user identifiers. For example, determining a user metric can be based on team identifiers (e.g., for comparing user metrics across teams, such as teams associated with different sizes, projects, expertise areas, etc.). In a first specific example, the method 100 can include determining a first metric for a first set of users (e.g., an “adaptability” aggregate metric describing a first team) associated with a first team identifier; determining a second metric (e.g., an “essential performance” aggregate metric describing a second team) for a second set of users (e.g., where the first and second set of users can share users, and where individual metrics for the shared users can be used in determining both the first and the second metric; etc.) associated with a second team identifier; and presenting the first and second metrics to a user (e.g., a manager of the first and second teams) based on a role identifier associated with the user, the first team identifier, and the second team identifier (e.g., where the user identifiers indicate the manager's role as the manager of the first and second teams). The method 100 can additionally or alternatively include receiving a first and second response to the first and second metric, respectively, from the user; and generating an additional metric (e.g., describing alignment of the user) based on the first and second responses. Additionally or alternatively, the method 100 can include determining a first change between the first metric and an updated first metric for the first set of users (e.g., where the updated first metric is associated with a second time period after a first time period associated with the first metric); determining a second change between the second metric and an updated second metric for the second set of users (e.g., where the updated second metric is associated with the second time period); and presenting the first and second changes to the user to improve display of cross-team information associated with the second user. In examples, determining user metrics can be based on: role identifiers (e.g., determining user metrics personalized to the role of the user whom the user metric is describing, such as a “sales performance” metric for a salesperson role; personalized to the role of the user who will be viewing the user metric, such as an aggregate “team performance” metric for a manager evaluating their team; etc.), project identifiers (e.g., determining user metrics at a greater frequency for short-term projects than for a long-term project; etc.), workplace identifiers (e.g., determining different user metrics for a manufacturing facility versus a software company; etc.), and/or any other suitable identifiers associated with users. However, determining user metrics based on user identifiers can be performed in any suitable manner.

In a third variation, determining a user metric can be based on contextual features. In a first example, the amount of user metric value increase or decrease can be determined based on user proximity (e.g., positional proximity; temporal proximity; workplace role relationship proximity; etc.) to a related event. In a first specific example, determining a user metric can include using a correlation between first location data (e.g., describing location of the user when the user responded to a query) and the user metric (e.g., a correlation of higher performance when the user is working at their desk; etc.) to generate a first user metric based on the query response and the first location data. Additionally or alternatively, the method 100 can include collecting second location data associated with a second response (e.g., received after the first response) and sampled at the location sensor; generating a comparison between the first location data and the second location data (e.g., identifying locations associated with the location data, and/or associating the locations with the corresponding responses; identifying a correlation of higher engagement when the user is working at the workplace headquarters versus working from home; etc.); and generating an aggregate metric based on the first user metric (e.g., determined from the first response), a second user metric (e.g., determined from the second response), and the location data comparison (e.g., assigning different weights to the first and second user metrics in determining the aggregate metric, based on the different locations; etc.). In a second specific example, the work stress management score can be increased when the work stress management kudos is received within a predetermined period of time after a stressful meeting has ended (e.g., where a stressful meeting can be identified as a meeting with the user's superiors, etc.). In a second example, the method 100 can include: identifying an event associated with a workplace (e.g., where the event occurs between interaction sessions such as query check-ins; where the event is associated with a time period between a first time condition for a first query, and a second time condition for a second query); determining a correlation between the event and a user metric (e.g., where the event is an educational course leading to an increase in performance metrics), where an additional user metric can be determined based on the correlation (e.g., a metric describing the effect of the event on the user metric in relation to historic values of the user metric; a metric describing the length of the effect of the event, such as whether the event effectuated a short-term or long-term change; etc.). In a specific example, identifying an event can include determining stock prices (e.g., downward trend of stock prices) associated with the workplace during a time period; determining a metric (e.g., negative morale) during the time period; determining a correlation between the stock prices and the metric; and presenting the correlation (e.g., to a manager, etc.). In another specific example, the method 100 can include identifying users with a metric satisfying a threshold condition during the time period (e.g., users with positive morale despite a downward trend of stock prices, etc.). In another specific example, upward trends of stock prices can be correlated with metrics and/or validation constructs (e.g., achievements posted by users, etc.). In another specific example, determining a user metric can be based on correlations between user metrics and physical activity parameters (e.g., extracted from inertial sensor data, such as data sampled by accelerometers and/or gyroscopes, etc.). However, determining user metrics based on contextual features can be performed in any suitable manner.

Determining user metrics can optionally include determining user metrics according to one or more computer-implemented rules (e.g., a feature selection rule; a user preference rule; etc.). For example, applying computer-implemented rules can include extracting user factors based on applying feature selection rules (e.g., feature selection algorithms such as exhaustive, best first, simulated annealing, greedy forward, greedy backward, and/or other suitable feature selection algorithms) to filter, rank, and/or otherwise select user factors for use in determining user metrics (e.g., through generating metric models). Feature selection rules can select features based on optimizing for processing speed, accuracy, storage, retrieval, and/or any other suitable criteria. Computer-implemented rules can be applied uniformly or differently across different user data types, entities described by user identifiers, and/or other suitable entities. However, determining user metrics based on computer-implemented rules can be performed in any suitable manner.

Determining user metrics can optionally include weighting user data and/or other suitable data used in determining the user metrics. The weights can be predetermined, dynamically determined, or otherwise determined. The weight can be determined based on the data source (e.g., where user responses are weighted higher than validation constructs, which are weighted higher than social networking systems), based on the age of the data, based on the user generating the data (e.g., based on the content-generating user's social relationship with the user under analysis, based on the frequency of their interaction, based on the validation construct history between the user and other users, based on the content-generating user's role relationship with the user under analysis, based on the workplace standing, based on the level of expertise of the content-generating user such as in relation to the expertise area associated with the content, etc.), based on the data's temporal proximity to an event, and/or based on any other suitable parameter. In a first example, user factor values extracted from a validation construct received for a first user from a second user can be weighted more when the frequency of interaction between the first and second user is low (e.g., below a threshold level), and is downgraded when the interaction frequency is high (e.g., when the first and second users frequently trade validation constructs beyond a threshold frequency). In a second example, user factor values extracted from a validation construct with comments can be weighted higher than user factor values extracted from a validation construct without comments. In a third example, user factor values extracted from a validation construct received from a teammate or direct manager can be weighted higher than user factor values extracted from a validation construct received from a subordinate or coworker outside of the user's team. In a fourth example, user factor values extracted from a social networking system can be weighted lower than user factor values extracted from user responses and/or validation constructs received from secondary users. In a fifth example, user factor values extracted from nonresponse to the queries can be weighted lower (e.g., have a less negative effect on the total user factor value) when the user had a meeting during the response period (e.g., as determined from a calendar associated with the user account). In a first specific example, the method 100 can include: receiving a validation construct from a second user (e.g., at a client system associated with the second user) for a first user; determining a first weight for the validation construct based on a first expertise area identifier and a second expertise area identifier associated with the first and second users, respectively; determining a second weight for the validation construction based on a set of historical validation constructions associated with the first and second users; and generating an aggregate metric (e.g., for the first and/or second user) based on the validation construct and the first and second weights. However, utilizing weights can be performed in any suitable manner.

Determining user metrics can optionally include determining user metrics with a metric model (and/or other suitable analysis modules). In a first variation, applying a metric model can include determining a pattern in the factor value set, matching the pattern to a known pattern, and selecting a user metric associated with the known pattern. In a second variation, applying a metric model can include calculating the metric value from the factor values and an equation associated with the metric value. In a third variation, applying a metric model can include calculating a probability for each of a set of metric values, based on the factor values, and selecting the metric value with the highest probability. Different metric models (e.g., generated with different algorithms, with different sets of user factors, with different input and/or output types, etc.) can be generated, applied, stored, retrieved, and/or otherwise processed for different user data types, different entities described by user identifiers, and/or for any suitable entities. For example, the method 100 can include storing a first metric model in association with a first role identifier at a remote metric system to improve data storage and data retrieval by the remote metric system; generating a first metric based on the first metric model and a first query response (e.g., by a first user associated with the first role identifier; etc.); and storing a second metric model in association with a second role identifier at the remote metric system to improve the data storage and data retrieval; generating a second metric based on the second metric model and a second query response (e.g., by a second user associated with the second role identifier; by the first user, who is also associated with the second role identifier). Processing a plurality of metric models suited to different contexts can confer improvements to the metric system by improving metric determination accuracy (e.g., by tailoring analysis to specific users, teams, workplaces, etc.), retrieval speed for the appropriate metric model from a database (e.g., by associating customized metric models with particular user accounts and/or other user identifiers), training and/or execution of metric models (e.g., where the customized metric models are associated with a subset of a pool of potential user factors correlated with the user metrics, and where the remaining unselected user factors are less correlated with the user metrics), and/or other suitable aspects of the processing system. However, any suitable number and/or type of metric models can be processed in any suitable manner.

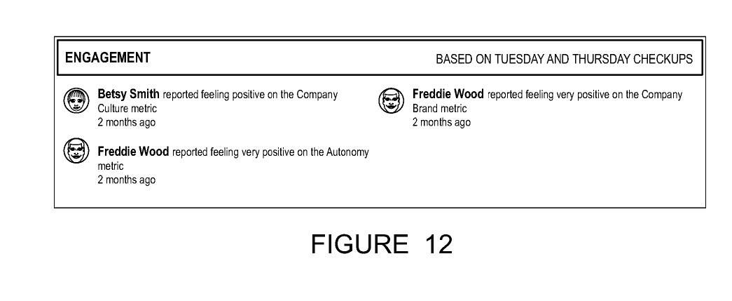

Determining user metrics can optionally include determining summary data (and/or other suitable aggregate user metrics). Summary data can include and/or be generated from: user metric values (e.g., metric scores), graphs, charts, diagrams, content snippets (e.g., from a second user's comment), comparisons between entities associated with user identifiers (e.g., users, roles, teams, workplaces etc.), comparisons over time (e.g., a comparison of user metrics for the same user at different points in time; etc.), and/or any other suitable summary data. The summary data can be for a specific user, a group of users (e.g., a project team or department), or any suitable user set. The summary data can be for a predetermined time period (e.g., a week, a quarter, a month, etc.) or for any suitable time period. The summary data is preferably determined from user metrics (or other data) for the users within the user set, but can alternatively be determined from data for users outside of the user set, such as users hierarchically above, below, adjacent, or otherwise related to the user set. For example, determining summary data can include generating a snippet from the user metrics (examples shown in FIGS. 12-13). In a first specific example, determining summary data can include detecting a change in a metric based on the factor values, identifying the data sources used to detect the change, and generating the snippet from the data sources. In a second specific example, the snippet can be extracted from a comment associated with a validation construct received for the user, where NLP can be used to identify key portions of the comment associated with the metric. In a third specific example, the snippet can be automatically generated based on auxiliary data sources (e.g., the snippet can be a summary of the number of tasks completed by a user, as automatically determined from the number of tasks marked “done” on a project task program). In a fourth specific example, selected validation constructs (“kudos”, “achievements”) can be displayed, based on how much “agreement” they received when second and third users responded to them through a review. However, determining summary data can be performed in any suitable manner.

Determining user metrics can be performed at predetermined time intervals (e.g., every day, week, etc.), in response to satisfaction of a condition (e.g., manager request to view a user metric; receipt of a query response and/or other suitable user data; received data exceeding a data amount or data type threshold; etc.), and/or at any suitable time and/or frequency. However, determining user metrics can be performed in any suitable manner.

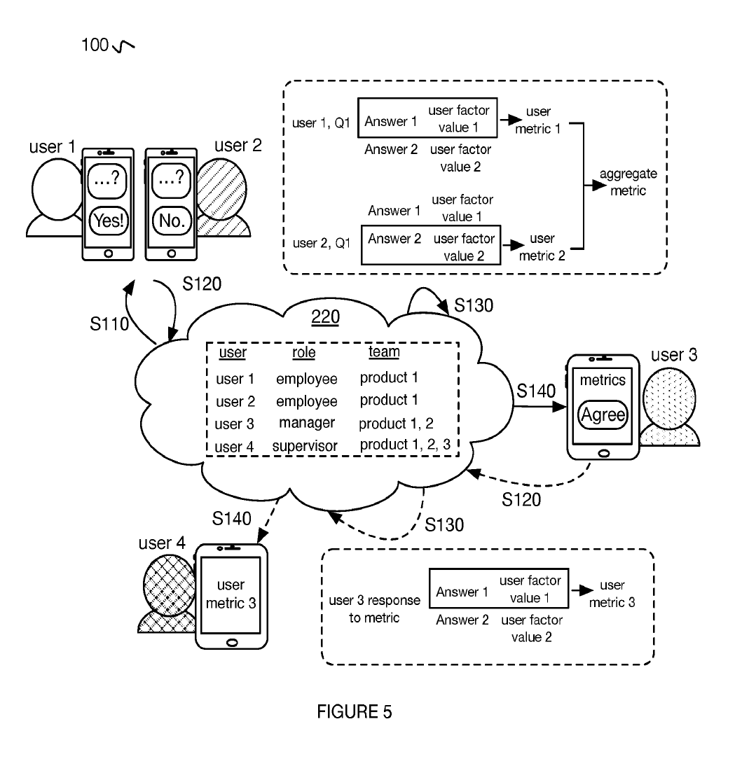

Presenting the metric to a second user based on a second role identifier identifying a second workplace role for the second user S140 can function to present a user metric to relevant users (e.g., managers) who are associated (e.g., in relation to workplace role) with the user whom the user metric is describing. Additionally or alternatively, presenting user metrics can function to notify users of an issue (e.g., an imminent issue, etc.), mitigate the effect of the issue occurrence on other users, prevent the issue from occurring, and/or other suitable functionality. For example, as shown in FIG. 5, presenting a metric can include presenting a first aggregate metric (e.g., a team engagement metric generated based on user metrics for the individual team members, etc.) to a user (e.g., a manager) based on an association between role identifiers (e.g., between a first role identifier and a second role identifier indicating a hierarchical relationship between the manager and a member of a team managed by the manager; between the second role identifier and a third role identifier indicating a hierarchical relationship between the manager and a supervisor who supervises the manager; etc.).

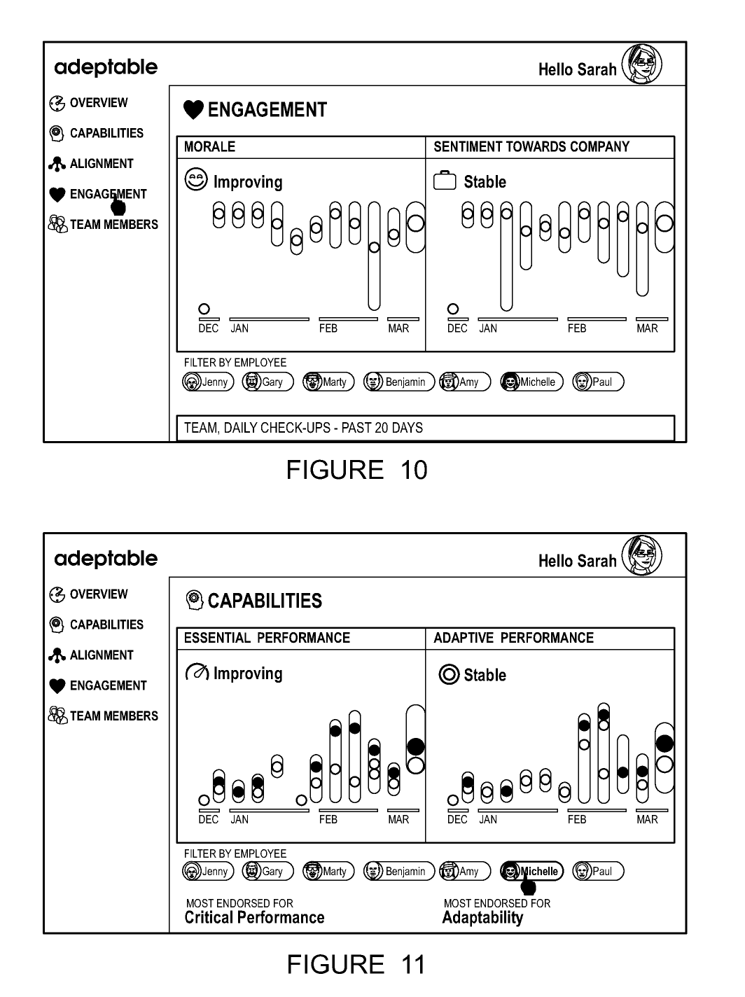

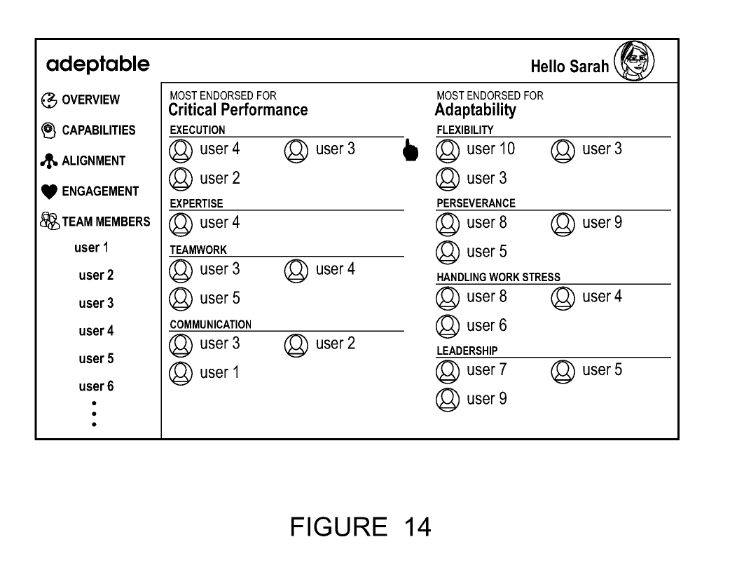

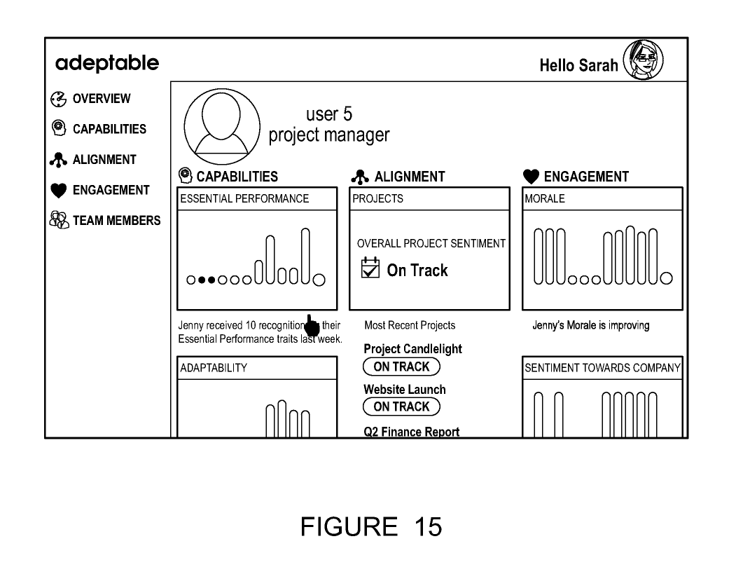

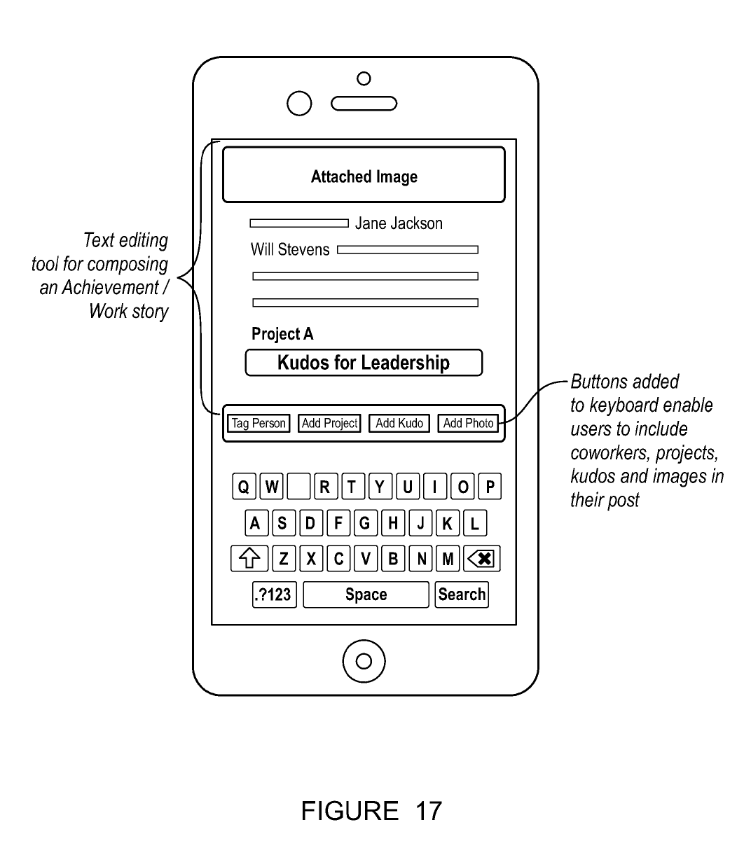

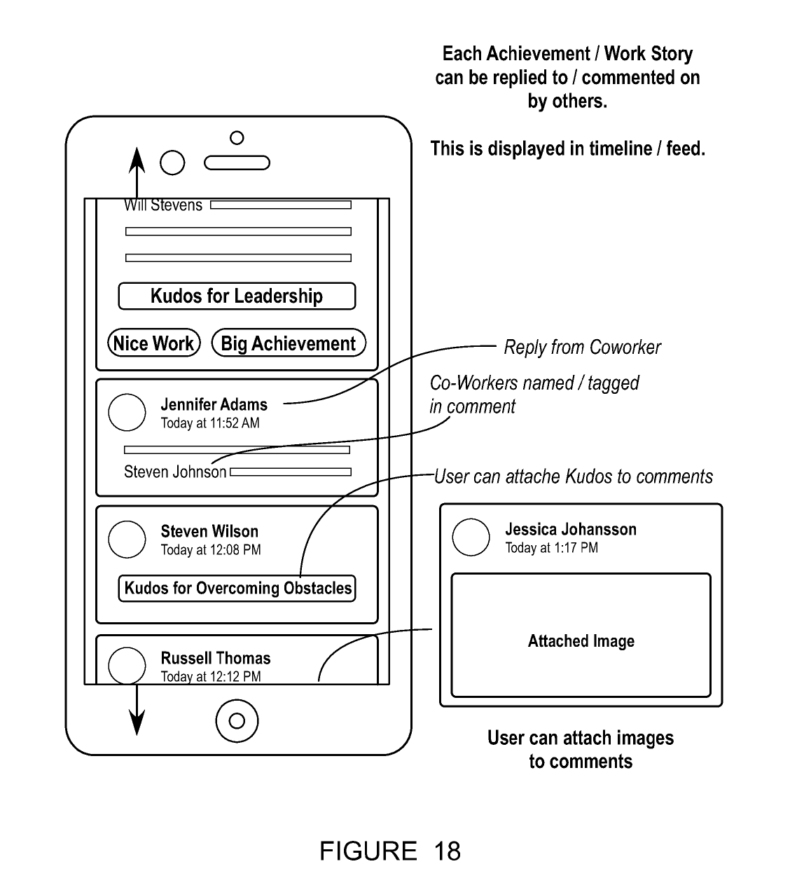

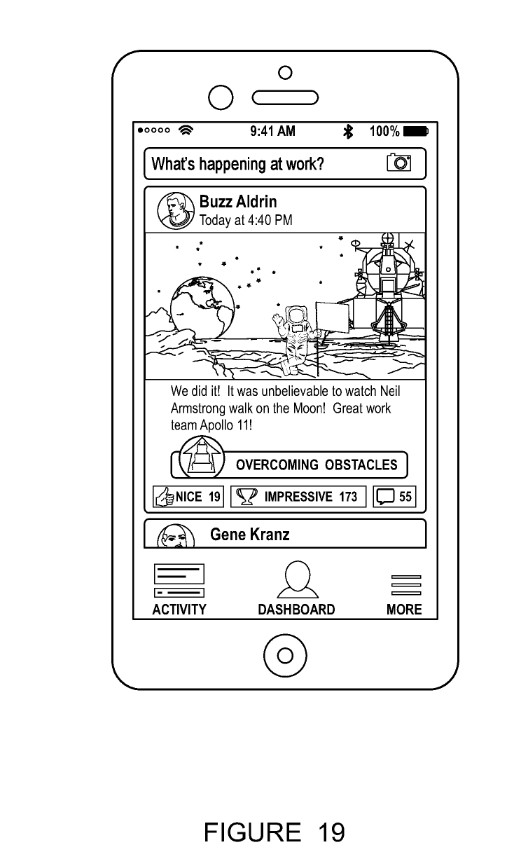

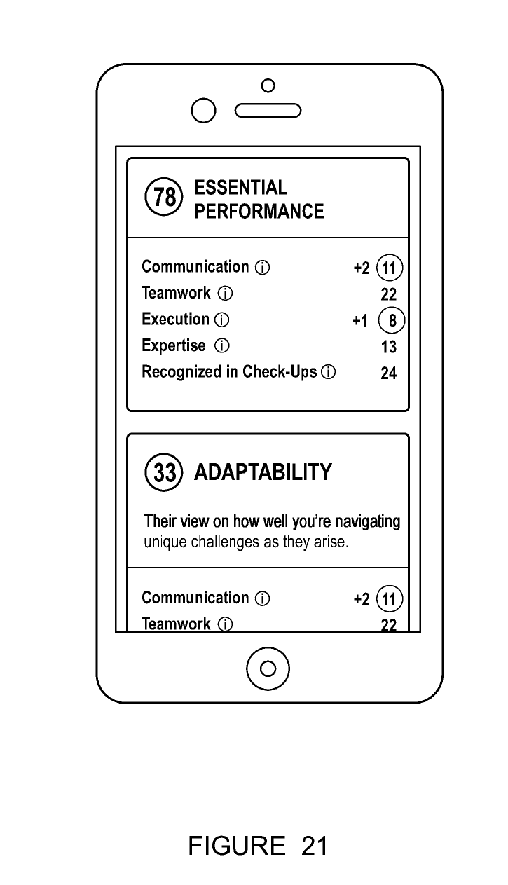

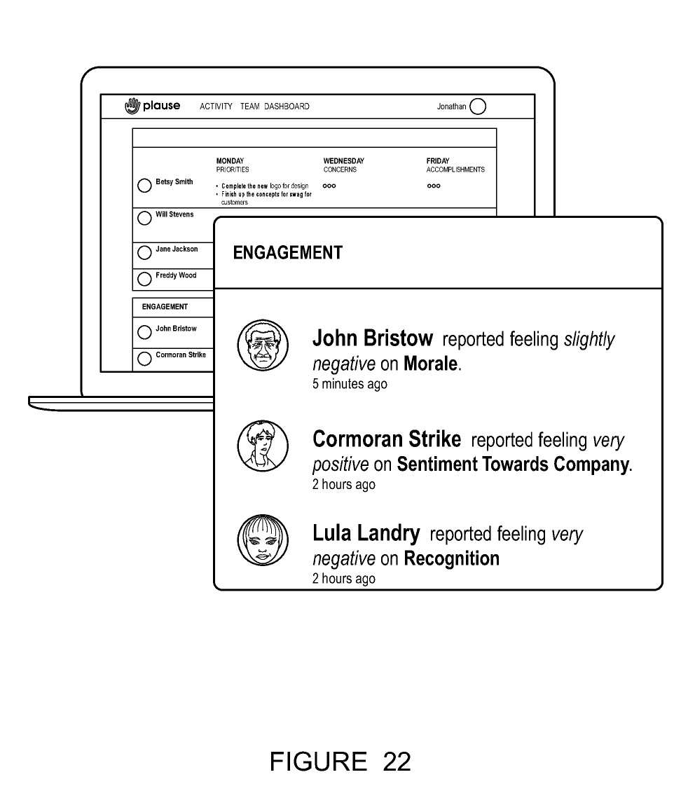

Presenting user metrics can optionally include generating a user interface (e.g., dashboard) from the user metrics (examples shown in FIGS. 10-22), which can function to improve display of cross-user data in a singular interface. In one example, the method 100 can include: determining the spread across each user metric for a set of users (e.g., a team), plotting the spread on a graph, and individually highlighting the respective user metric for a user of the set, when the user is selected on the interface (examples shown in FIGS. 10-11). However, user metrics can be presented according to any suitable format-related parameter. User metrics are preferably presented (e.g., displayed, played, etc.) through a client system (e.g., associated with the user who is viewing the user metrics, etc.), but can additionally or alternatively be presented at any other suitable client systems (e.g., associated with any suitable user account), user devices, and/or other components of the system. User metrics can be presented at predetermined time intervals, in response to receipt of a request from the second user (e.g., in response to selection to view the summary data), automatically (e.g., by sending a notification), in response to satisfaction of other conditions, and/or performed at any suitable time and/or frequency. For example, presenting a user metric (e.g., an aggregate metric describing a first and a second user) to a user (e.g., a third user) can be in response to the user metric satisfying a metric threshold condition (e.g., an alignment aggregate metric between the first and second users falling below an alignment metric threshold value, etc.). User metrics and/or other suitable user data can optionally be presented through a means of ‘virality’. User interactions with the user data can cause the system to republish that user data to the user's peers (organizational, project based, etc.), the user's manager, to the user themselves (e.g., in the form of a report if the a user is a manager), and/or any other suitable grouping, such as based on the degree of interactions with the user data. However, presenting metrics and/or other suitable user data to users can be performed in any suitable manner.

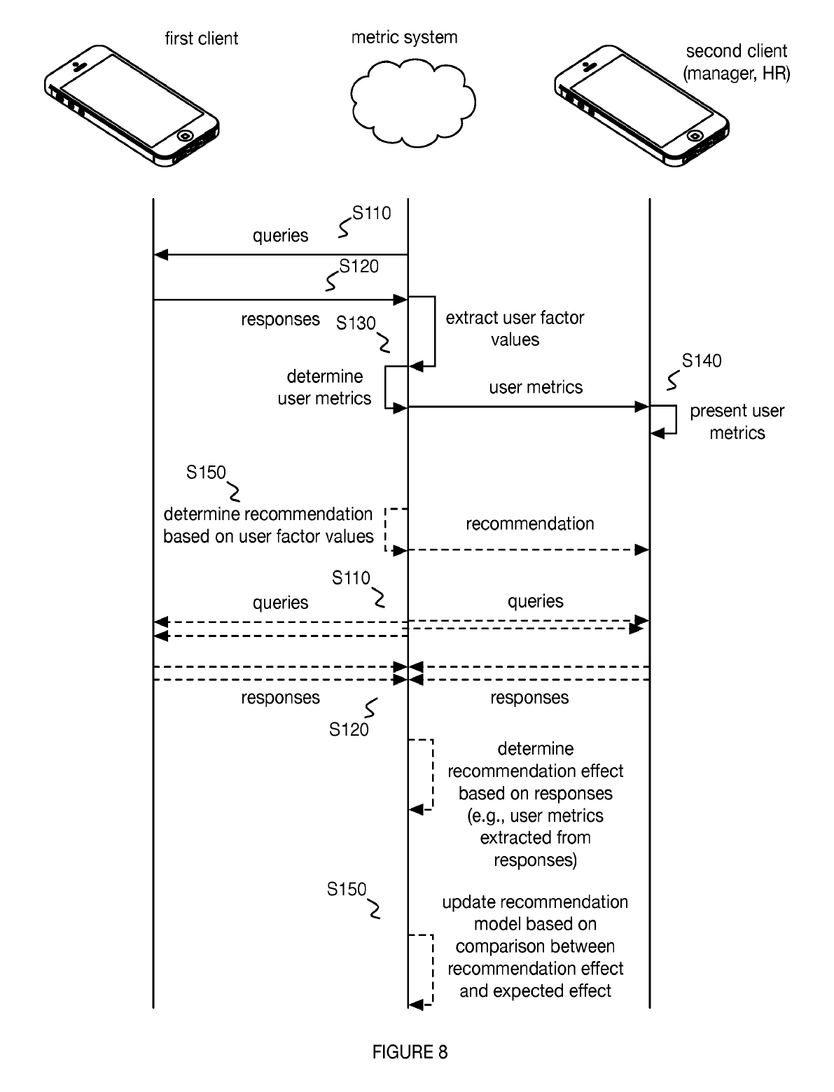

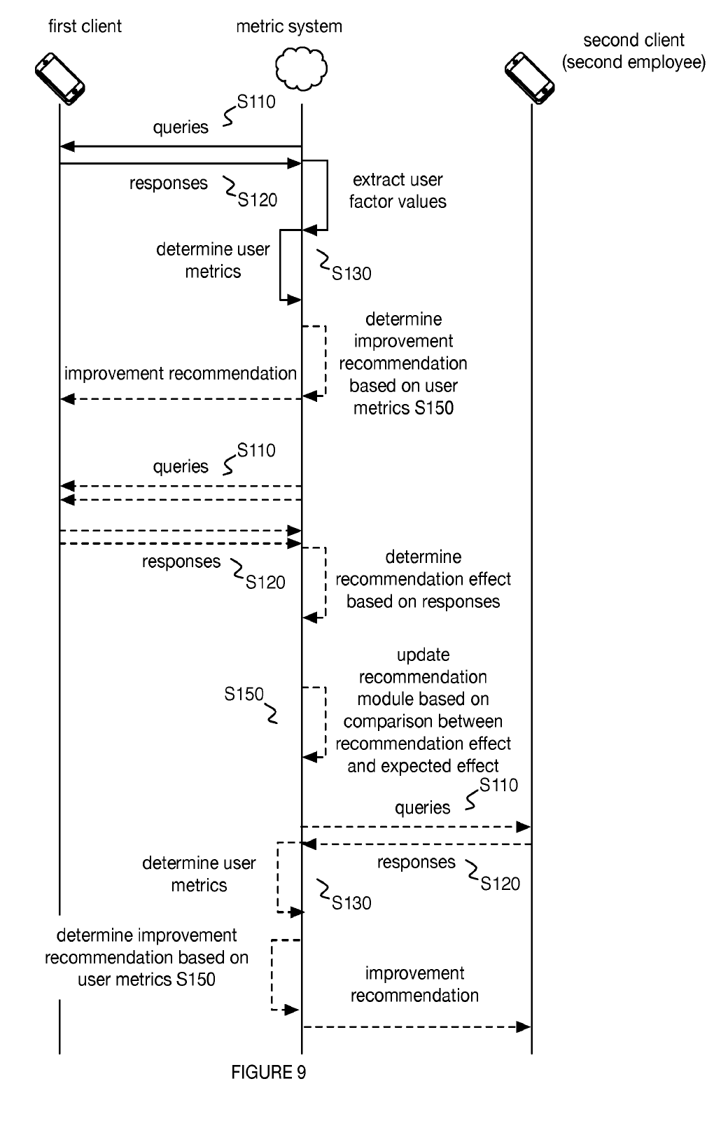

The method 100 can additionally or alternatively include determining a workplace action based on the user metric (and/or other suitable user data) S150, which can function to identify, initiate, and/or otherwise process actions associated with user metrics (e.g., actions for improving user metrics). Workplace actions can include: recommendations (e.g., as shown in FIGS. 8-9), therapeutic interventions (e.g., presenting audio therapy at the client system in response to determining a user metric indicating user stress; presenting therapies possessing any suitable format-related parameters; etc.), communication actions (e.g., facilitating digital communication between users, such as through video chat; automatically scheduling meetings between users; enabling users to schedule meetings; etc.), and/or any other suitable actions. In examples, generating a recommendation can be based on historic recommendations (and/or determined effectiveness of the recommendations) sent to users with similar user metrics, and/or any other suitable user data. Workplace actions can be determined using an analysis module (e.g., a recommendation model), be selected from a list of prescribed workplace actions for each predicted outcome, and/or be otherwise determined. The endpoint (e.g., the user account that the recommended action is sent to) can be determined based on the predicted outcome (e.g., type, intensity, immediacy), the specified endpoint for the predicted outcome type, and/or otherwise determined. However, determining workplace actions can be performed in any suitable manner.

In a variation, determining a recommendation can include evaluating the effect of the recommendation and updating the recommendation model, which can function to refine the recommended actions for each predicted outcome. In a first example, the method 100 can include: determining a recommended action (e.g., provide feedback at a greater frequency) for a second user (e.g., a manager) based on a first aggregate metric describing a first user (e.g., an engagement score for the first user below a threshold score); determining an updated aggregate metric based on a query response from the first user (e.g., received after the recommendation action), where the updated aggregate metric is associated with the recommendation (e.g., correlated); and updating the recommended action for the second user based on a difference between the updated aggregate metric and the first aggregate metric (e.g., selecting a different recommendation action in response to a lack of improvement in the aggregate metric). In a second example, the method 100 can include: predicting an imminent adverse event for a user based on the user metrics for the user, generating a recommended action based on the adverse event and a profile for the user, sending the recommended action to a second user account associated with a manager, verifying recommended action performance at a first time (e.g., through a query presented to the manager, through a query presented to the user, through a query presented to a third user account, by monitoring content generated by the user for changes in sentiment, etc.), tracking the user metrics associated with the adverse event for the user after the first time, reinforcing the recommendation model in response to the user metrics substantially matching an expected user metric change (e.g., updating the model based on the pre-recommendation user metrics, the recommended action, the expected user metric change, user profile, etc.), and retraining the recommendation model in response to the user metrics differing from the expected user metric change. Additionally or alternatively, the recommendation model can be otherwise updated, and determining workplace actions can be performed in any suitable manner.

Although omitted for conciseness, the preferred embodiments include every combination and permutation of the various system components and the various method processes, including any variations, embodiments, examples, and specific examples, where the method processes can be performed in any suitable order, sequentially or concurrently. The system and method and variations thereof can be embodied and/or implemented at least in part as a machine configured to receive a computer-readable medium storing computer-readable instructions. The instructions are preferably executed by computer-executable components preferably integrated with the system. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions. As a person skilled in the art will recognize from the previous detailed description and from the figures and claims, modifications and changes can be made to the preferred embodiments of the invention without departing from the scope of this invention defined in the following claims.

We claim:

1. A method for improving user metric determination associated with a workplace, the method comprising:
determining, at a remote metric system, a first query and a first time condition for a first user based on a first role identifier identifying a first workplace role associated with the first user;
collecting, at a first client system associated with the first user and the remote metric system, a first response to the first query before the first time condition;
generating, at the remote metric system, a first metric for the first user based on the first response, wherein the first metric is associated with the workplace;
determining, at the remote metric system, a second query and a second time condition based on the first response and the first role identifier;
generating, at the remote metric system, a second metric for the first user based on a second response collected for the second query before the second time condition, wherein the second metric is associated with the workplace;
generating, at the remote metric system, a first aggregate metric for the first user based on the first and second metrics; and
presenting, at a second client system associated with a second user and the remote metric system, the first aggregate metric based on an association between the first role identifier and a second role identifier identifying a second workplace role for the second user.

2. The method of claim 1, further comprising:
collecting, at the remote metric system, first location data associated with the first response and sampled at a location sensor of a user device executing the first client system,
wherein generating the first metric comprises using a correlation between the first location data and the first metric to generate the first metric based on the first response and the first location data.

3. The method of claim 2, further comprising:
collecting, at the remote metric system, second location data associated with the second response and sampled at the location sensor; and
generating a comparison between the first location data and the second location data,
wherein generating the first aggregate metric comprises generating the first aggregate metric based on the comparison and the first and the second metrics.

4. The method of claim 1, further comprising:
determining a recommended action for the second user based on the first aggregate metric;
determining an updated aggregate metric based on a third response collected for a third query for the first user, wherein the updated aggregate metric is associated with the recommendation; and
updating the recommended action for the second user based on a difference between the updated aggregate metric and the first aggregate metric.

5. The method of claim 1, further comprising:
receiving, at the second client system, a validation construct from the second user for the first user;
determining, at the remote metric system, a first weight for the validation construct based on a first expertise area identifier and a second expertise area identifier associated with the first and second users, respectively; and
generating, at the remote metric system, a second aggregate metric for the first user based on the validation construct and the first weight.

6. The method of claim 5, further comprising:
determining a third query and a third time condition based on the first and second aggregate metrics; and
determining a third metric for the first user based on a third response collected for the third query before the third time condition.

7. The method of claim 5, further comprising:
determining a second weight for the validation construction based on a set of historical validation constructions associated with the first and second users,
wherein generating the second aggregate metric comprises generating the second aggregate metric based on the validation construct and the first and second weights.

8. The method of claim 1, further comprising:
identifying an event associated with the workplace and a time period between the first and second time conditions; and
determining a correlation between the event and the second metric, wherein generating the first aggregate metric comprises generating the first aggregate metric based on the first metric and the correlation between the event and the second metric.

9. The method of claim 1, further comprising:
determining a third query for a third user based on a third role identifier identifying a third workplace role associated with the third user, wherein the third query is associated with the second time condition; and
generating a third metric for the third user based on a third response collected for the third query before the second time condition,
wherein generating the first aggregate metric comprises generating the first aggregate metric for the first and third users based on the first, second, and third metrics.

10. The method of claim 1, further comprising:
collecting, at the second client system, a timing preference from the second user,
wherein determining the first time condition comprises determining the first time condition based on the timing preference and the first role identifier,
wherein determining the second time condition comprises determining the second time condition based on the timing preference, the first role identifier, and the first response, and
wherein generating the first aggregate metric comprises generating the first aggregate metric in response to elapse of the second time condition.

11. A method for improving user metric determination associated with a workplace, the method comprising:
determining a query for a first user based on a first role identifier identifying a first workplace role for the first user;
generating a first metric for the first user based on a first response to the query from the first user;
presenting the first metric to a second user based on a first association between the first role identifier and a second role identifier identifying a second workplace role for the second user, wherein the first metric is associated with the workplace;
receiving a second response associated with the first metric from the second user;
generating a second metric for the second user based on the second response, wherein the second metric is associated with the workplace; and
presenting the second metric to a third user based on a second association between the second role identifier and a third role identifier identifying a third workplace role for the third user.

12. The method of claim 11,
obtaining a computer-implemented rule defining a metric threshold condition;
generating an aggregate metric for the first and second users based on the first and second responses; and
presenting the aggregate metric to the third user in response to the aggregate metric satisfying the metric threshold condition.

13. The method of claim 12, wherein the aggregate metric comprises an alignment score between the first and second users, and wherein presenting the aggregate metric comprises presenting the aggregate metric to the third user in response to the alignment score being below a metric threshold defined by the metric threshold condition.

14. The method of claim 11, further comprising:
storing a first metric model in association with the first role identifier at a remote metric system to improve data storage and data retrieval by the remote metric system, wherein generating the first metric comprises generating the first metric based on the first metric model and the first response; and
storing a second metric model in association with the second role identifier at the remote metric system to improve the data storage and data retrieval, wherein generating the second metric comprises generating the second metric based on the second metric model and the second response.

15. The method of claim 11, wherein presenting the first metric comprises presenting the first metric to the second user at a first time period, wherein receiving the second response associated with the first metric comprises receiving the second response at a second time period after the first time period, and wherein generating the second metric comprises generating the second metric based on the second response and the first and second time periods.

16. The method of claim 15, wherein the second metric comprises an engagement score for the second user in relation to the workplace, and wherein generating the second metric comprises generating the engagement score based on the second response, and a time difference between the first and second time periods.

17. The method of claim 11, further comprising:
determining a first aggregate metric for a first set of users comprising the first user based on the first metric, wherein the first set of users is associated with a first team identifier;
determining a second aggregate metric for a second set of users associated with a second team identifier; and
presenting the first and second aggregate metrics to the second user based on the second role identifier, the first team identifier, and the second team identifier.

18. The method of claim 17, wherein receiving the second response comprises receiving the second response to the first aggregate metric from the second user, and the method further comprising receiving a third response to the second aggregate metric from the second user, wherein generating the second metric comprises generating the second metric based on the second and third responses.

19. The method of claim 17, wherein the first and second aggregate metrics are associated with a first time period, and the method further comprising:
determining a first change between the first aggregate metric and an updated first aggregate metric for the first set of users, wherein the updated first aggregate metric is associated with a second time period after the first time period;
determining a second change between the second aggregate metric and an updated second aggregate metric for the second set of users, wherein the updated second aggregate metric is associated with the second time period; and
presenting the first and second changes to the second user to improve display of cross-team information associated with the second user.

20. The method of claim 17, wherein the second set of users comprises the first user, and wherein determining the second aggregate metric for the second set of users comprises determining the second aggregate metric based on the first metric.
